(19) United States
(12) Patent Application Publication
(10) Pub. No.: US 2017/0249355 A1
(43) Pub. Date: Aug. 31, 2017

(54) ELECTRONIC DEVICE AND METHOD OF PROCESSING USER INPUT BY ELECTRONIC DEVICE

(71) Applicant: SAMSUNG ELECTRONICS CO., LTD., Suwon-si (KR)

(72) Inventors: Min-Gu KANG, Suwon-si (KR); Gi-Beom KIM, Seongnam-si (KR); Jae-Hyun KIM, Suwon-si (KR); Myeong-Hwan NAM, Suwon-si (KR); Bu-Seop JUNG, Hwaseong-si (KR); Young-Jae CHOI, Suwon-si (KR); Hyuk KANG, Yongin-si (KR); Kyung-Tae KIM, Hwaseong-si (KR); Tae-Gun PARK, Hwaseong-si (KR); Jae-Bong YOO, Seongnam-si (KR); Jun-Hak LIM, Suwon-si (KR); In-Ji JIN, Bucheon-si (KR)

(21) Appl. No.: 15/426,239

(22) Filed: Feb. 7, 2017

(30) Foreign Application Priority Data
Feb. 26, 2016 (KR) 10-2016-0023733

(51) Int. Cl. G06F 17/30; G06Q 20/10; G06F 3/16

(52) U.S. Cl. CPC G06F 17/30395; G06F 3/16; G06Q 20/10

(57) ABSTRACT

Disclosed are an electronic device and a method of processing a user input by an electronic device. The method includes: generating a first query based on an input; identifying a response to the first query; transmitting a second query generated at least based on the first query to an external electronic device, which can perform short-range communication, through communication circuitry of at least one communication module, based on a result of the response; and setting the second query to be processed by the external electronic device.

### CROSS-REFERENCE TO RELATED APPLICATION

This application is based on and claims priority under 35 U.S.C. §119 to Korean Application Serial No. 10-2016-0023733, which was filed in the Korean Intellectual Property Office on Feb. 26, 2016, the content of which is incorporated by reference herein in its entirety.

### TECHNICAL FIELD

The present disclosure relates generally to an electronic device and a method of processing a user input by an electronic device.

### BACKGROUND

Recently used various electronic devices have been developed to receive user inputs and to perform tasks corresponding to the received user inputs. For example, electronic devices (for example, smart phones or servers) may transmit a user input to a server and make a control to output received data corresponding to the transmission as an input corresponding to the user input.

Recently used various electronic devices have been developed to use various functions. The electronic device has a display unit to more effectively use various functions. For example, in the case of recent smart phones, a touch-sensitive display unit (for example, a touch screen) is provided on the front surface thereof.

In addition, various types of applications (for example, referred to as “Apps”) may be installed and executed in electronic devices. Various input means (for example, a touch screen, buttons, a mouse, a keyboard, a sensor or the like) may be used to execute and control the applications in the electronic device.

### SUMMARY

An electronic device may identify a task corresponding to a user input and determine whether the task can be processed. The electronic device may determine whether the task can be processed based on a sensor or data stored therein.

When the electronic device cannot identify the task corresponding to the user input or a component required for performing the task is not included in the electronic device, the user may make a user input again into another electronic device and identify a processing result.

According to various example embodiments of the present disclosure, an electronic device and a method of processing a user input by an electronic device may transmit a user input received by the electronic device to an external electronic device based on whether a task corresponding to the user input can be processed and the external electronic device may perform the task and output a result of the performance.

In accordance with an example aspect of the present disclosure, an electronic device is provided. The electronic device includes: at least one communication module comprising communication circuitry; and a processor comprising processing circuitry, wherein the processor is configured to generate a first query based on an input, to identify a response to the first query, and to transmit a second query generated at least based on the first query to an external electronic device, which can perform short-range communication, through the communication circuitry based on a result of the response to process the second query by the external electronic device.

In accordance with another example aspect of the present disclosure, an electronic device is provided. The electronic device includes: a communication module comprising communication circuitry; and a processor comprising processing circuitry, wherein the processor is configured to acquire a query from a user corresponding to the electronic device, to identify a data domain corresponding to a task to be performed in connection with the query, to determine whether an external electronic device corresponding to the user can perform the task at least based on the data domain, and to transmit at least a part of the query or a response to the query to the external electronic device through the communication circuitry at least based on the determination that the external electronic device can perform the task.

In accordance with another example aspect of the present disclosure, a method of processing an input by an electronic device is provided. The method includes: generating a first query based on a received input; identifying a response to the first query; transmitting a second query generated at least based on the first query to an external electronic device, which can perform short-range communication, through at least one communication module comprising communication circuitry, based on a result of the response; and setting the second query to be processed by the external electronic device.

In accordance with another example aspect of the present disclosure, a method of processing a user input by an electronic device is provided. The method includes: acquiring a query corresponding to the electronic device; identifying a data domain corresponding to a task to be performed in connection with the query; determining whether an external electronic device corresponding to the user can perform the task at least based on the data domain; and transmitting at least a part of the query or a response to the query to the external electronic device through communication circuitry of a communication module at least based on the determination that the external electronic device can perform the task.

In accordance with another example aspect of the present disclosure, a storage medium storing instructions which, when executed, cause at least one processor to perform at least one operation is provided. The at least one operation includes: generating a first query based on an input; identifying a response to the first query; transmitting a second query generated at least based on the first query to an external electronic device, which can perform short-range communication, through at least one communication module comprising communication circuitry based on a result of the response; and setting the second query to be processed by the external electronic device.

In an electronic device and a method of processing an input by an electronic device according to various example embodiments of the present disclosure, an input (e.g., a user input) received by the electronic device may be transmitted to an external electronic device based on whether a task corresponding to the user input can be processed and a result of the performance of the task may be output through the external electronic device, so that a user can identify a processing result of the task through the external electronic device without making the user input again.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a diagram illustrating an example of a configuration of a system that processes a user input according to various example embodiments of the present disclosure;

FIG. 2 is a block diagram illustrating an example of a configuration of an electronic device according to various example embodiments of the present disclosure;

FIG. 3 is a flowchart illustrating an example of an operation of processing a user input by an electronic device according to various example embodiments of the present disclosure;

FIG. 4 is a flowchart illustrating an example of an operation of performing a handoff to an external electronic device based on whether an electronic device can process a user input according to various example embodiments of the present disclosure;

FIG. 5 is a flowchart illustrating an example of an operation for processing a user input between at least one electronic device and a server according to various example embodiments of the present disclosure;

FIG. 6 is a block diagram illustrating an example of an advertising packet structure transmitted by an electronic device to discover a handoff electronic device according to various example embodiments of the present disclosure;

FIG. 7 is a diagram illustrating an example of a situation in which an electronic device performs a handoff based on a user input according to various example embodiments of the present disclosure;

FIG. 8 is a diagram illustrating an example of a situation in which a result of performance of a user input is identified through a handoff electronic device according to various example embodiments of the present disclosure;

FIG. 9 is a diagram illustrating an example of a situation in which an electronic device performs a handoff corresponding to a user input and outputs a result of the performance according to various example embodiments of the present disclosure;

FIG. 10 is a diagram illustrating an example of a situation in which a query handed off from an external electronic device is processed according to various example embodiments of the present disclosure;

FIG. 11 is a sequence diagram illustrating an example of an operation in which a user input between at least one electronic device and a server is processed according to various example embodiments of the present disclosure;

FIG. 12 is a diagram illustrating an example of a situation in which an electronic device processes a user input according to various example embodiments of the present disclosure;

FIG. 13 is a diagram illustrating an example of a situation in which an electronic device inquiries about whether to perform a handoff based on a user input according to various example embodiments of the present disclosure;

FIG. 14 is a block diagram illustrating an example of a domain information structure according to various example embodiments of the present disclosure;

FIG. 15 is a diagram illustrating an example of a configuration of a system for processing a user input according to various example embodiments of the present disclosure;

FIG. 16 is a diagram illustrating an example of a configuration of a system that processes a user input according to various example embodiments of the present disclosure;

FIG. 17 is a diagram illustrating an example of a configuration of a system that processes a user input according to various example embodiments of the present disclosure;

FIG. 18 is a diagram illustrating an example of a configuration of a system that processes a user input according to various example embodiments of the present disclosure;

FIG. 19 is a diagram illustrating an example of a configuration of a system for processing a user input according to various example embodiments of the present disclosure;

FIG. 20 is a flowchart illustrating an example of an operation of processing a user input by an electronic device according to various example embodiments of the present disclosure;

FIG. 21 is a flowchart illustrating an example of an operation of processing a user input by an electronic device according to various example embodiments of the present disclosure;

FIG. 22 is a flowchart illustrating an example of an operation for processing a user input by an electronic device according to various example embodiments of the present disclosure;

FIG. 23 is a diagram illustrating an example of a configuration of a system that processes a user input according to various example embodiments of the present disclosure;

FIG. 24 is a flowchart illustrating an example of an operation for processing a user input by an electronic device according to various example embodiments of the present disclosure;

FIG. 25 is a diagram illustrating an example of a configuration of a system for processing a user input according to various example embodiments of the present disclosure;

FIG. 26 is a block diagram illustrating an example of a configuration of an electronic device according to various example embodiments of the present disclosure;

FIG. 27 is a block diagram illustrating an example of a server configuration according to various example embodiments of the present disclosure;

FIG. 28 is a diagram illustrating an example of a configuration of a system that processes a user input according to various example embodiments of the present disclosure;

FIG. 29 is a block diagram illustrating an example of a configuration of an electronic device according to various example embodiments of the present disclosure;

FIG. 30 is a diagram illustrating an example of a configuration of a system that processes a user input according to various example embodiments of the present disclosure;

FIG. 31 is a flowchart illustrating an example of an operation in which a server processes a user input according to various example embodiments of the present disclosure;

FIG. 32 is a flowchart illustrating an example of an operation for processing a user input by an electronic device according to various example embodiments of the present disclosure;

FIG. 33 is a block diagram illustrating an example network environment, according to various example embodiments of the present disclosure;

FIG. 34 is a block diagram illustrating an example configuration of an electronic device according to various example embodiments of the present disclosure; and

FIG. 35 is a block diagram illustrating an example configuration of a program module according to various example embodiments of the present disclosure.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer, for example, to a situation in which the device, together with other devices or components, “is able to”. For example, the phrase “processor adapted (or configured) to perform A, B, and C” may refer, for example, to processing circuitry, a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe various example embodiments, and are not intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even terms defined herein should not be construed to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HIVID)), a fabric or clothing integrated type (e.g., an electronic clothing), a body-mounted type (e.g., a skin pad, or tattoo), and a bio-implantable type (e.g., an implantable circuit), or the like, but is not limited thereto.

According to various embodiments of the present disclosure, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to various embodiments of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

According to various embodiments of the present disclosure, a handoff may, for example, correspond to an operation of transmitting a received query to a server and switching a subject of an operation for processing a response to the query, and a first electronic device having received the query may transmit the received query to a second electronic device. For example, data transmitted in the handoff may include information that makes a request for performing an operation for a particular query.

According to various embodiments of the present disclosure, the query may include data that identifies a task which can be performed in connection with a user input and makes a request for domain information for performing the task.

According to various embodiments of the present disclosure, the domain information may indicate, for example, a structure between operations for performing the task for processing the user input and may include information, a type of a supportable electronic device (for example, a smart phone or a TV), information on an operation (for example, phone application execution) which should be performed for a particular task (for example, a phone call), or information on a relationship between operations. For example, the task may include a phone call, a text message, finding a contact, and a memo.

Hereinafter, an electronic device and a method of processing a user input by an electronic device according to various embodiments of the present disclosure will be described with reference to the accompanying drawings. In the present disclosure, the term “user” may refer to a person or a device (for example, an artificial intelligence electronic device) that uses an electronic device.

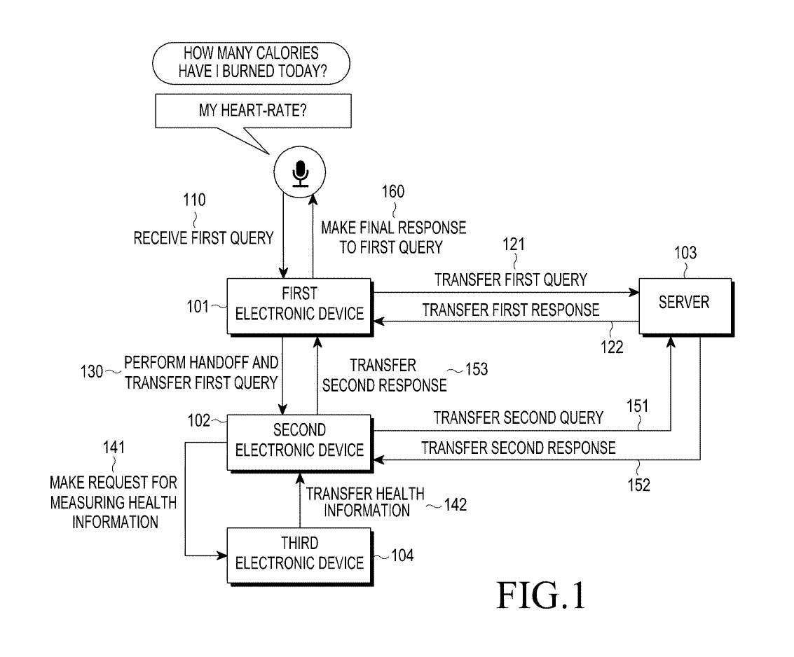

FIG. 1 is a diagram illustrating an example of a configuration of a system that processes a user input according to various example embodiments of the present disclosure.

Referring to FIG. 1, the system may include at least one electronic device (for example, a first electronic device 101, a second electronic device 102, or a third electronic device 104), or a server 103. For example, the first electronic device 101, the second electronic device 102, and the third electronic device 104 may be devices connected to each other through short-range communication.

According to various embodiments of the present disclosure, at least one electronic device may identify that each device is located within a predetermined distance through short-range communication or identify information on neighboring devices of a hub device through information received from the hub device. For example, the hub device may relay communication between electronic devices and transmit information on devices located near the hub device to another electronic device.

In operation 110, the first electronic device 101 may receive a user input (for example, voice data) through an input/output module of the first electronic device 101. For example, the input/output module may include a microphone, a speaker, a sensor, or a display, and further include various elements for identifying other input data and outputting the data.

In operation 121, the first electronic device 101 may transmit a first query related to the received user input to the server 103. For example, the first query may include information on a function, module, and sensor of the first electronic device 101.

According to various embodiments of the present disclosure, the user input may correspond to data that makes a request for identifying the number of calories burned today (for example, “how many calories have I burned today?”) or data that makes a request for identifying a heart-rate (for example, “my heart-rate?”) and may be received by the first electronic device 101 in the form of voice data or text data.

In operation 122, the server 103 may identify operation information related to the user input and transmit a first response to the first electronic device 101 as a response to the first query.

According to various embodiments of the present disclosure, the first response may include a positive response or a negative response to the corresponding user input. For example, the positive response may include a command related to the user input, and the negative response may include information indicating that the electronic device 101 cannot process a task corresponding to the user input or there is no data required for processing the task.

In operation 130, the first electronic device 101 may determine the handoff to the second electronic device 102 (for example, a wearable device) and transmit the first query. For example, as the negative response to the first query is received, the first electronic device 101 may identify the second electronic device 102 as a device to perform an operation (for example, measuring health information) related to the user input. For example, the second electronic device 102 may correspond to a watch type electronic device that can be worn on the user's wrist and may measure a user's heart-rate.

In operation 141, the second electronic device 102 may transmit a message that makes a request for measuring health information (for example, burned calories) to the third electronic device 104. For example, the second electronic device may perform an operation related to measuring the health information corresponding to the user input. The second electronic device may identify the third electronic device 104 as an electronic device including a sensor, which can measure corresponding data that cannot be measured by the second electronic device among the requested health information.

In operation 142, the third electronic device 104 may identify the number of calories a user burned on a particular date and transmit the number of burned calories to the second electronic device 102. For example, the third electronic device 104 may include a sensor (for example, a motion sensor or an acceleration sensor) which may measure a user's motion and may determine the number of calories a user burns by identifying data measured by the sensor.

In operation 151, the second electronic device 102 may transmit a second query to the server 103. For example, the second query may include the user input included in the first query, the health information measured by the third electronic device 104, and information on the second electronic device 102.

In operation 152, the server 103 may transmit a second response to the second electronic device 102 as a response to the second query. For example, the second response may be a response to the same user input as the user input of the first electronic device 101 and may be information different from the first response to the first query according to the information on the second electronic device 102.

In operation 153, the second electronic device 102 may transmit the second response to the first electronic device 101.

In operation 160, the first electronic device 101 may identify the received second response as a final response to the user input. For example, the first electronic device 101 may output the second response or make a control to perform an operation related to the second response.

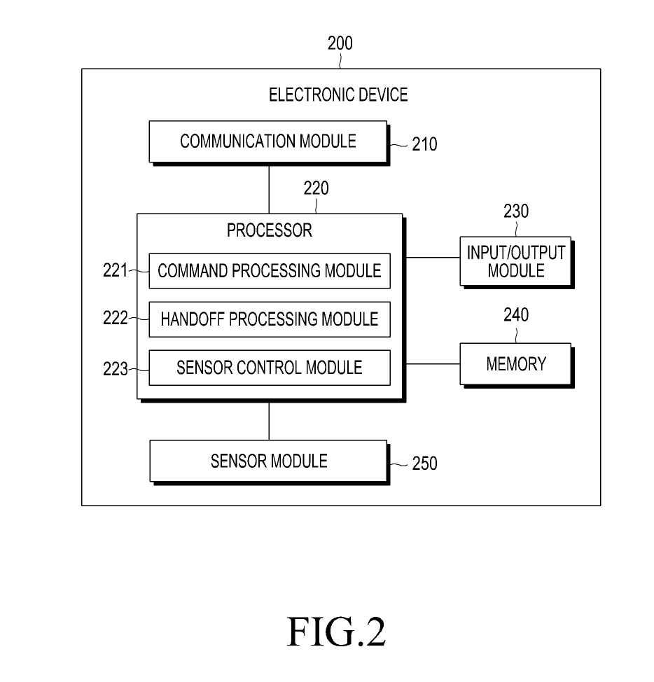

FIG. 2 is a block diagram illustrating an example of a configuration of an electronic device according to various example embodiments of the present disclosure.

Referring to FIG. 2, an electronic device 200 may include, for example, a communication module (e.g., including communication circuitry) 210 (for example, a communication module 3420), a processor (e.g., including processing circuitry) 220, an input/output module (e.g., including input/output circuitry) 230 (for example, an input device 3450 or a display 3460), a memory 240, or a sensor module 250, and further include various elements for receiving or output other user inputs and processing the user inputs.

The communication module 210 may include various communication circuitry configured to transmit a query to at least one external device (for example, the server or the second electronic device) and receive information on a task which can be performed in connection with the query as a response to the query.

The processor 220 may include a command processing module 221, a handoff processing module 222, or a sensor control module 223.

The processor 220 may transmit the query for the user input to at least one external device. For example, when a negative response is received in response to the query request for the user input, the processor 220 may identify at least one electronic device to perform the user input and make a request for processing to the user input to the identified device.

According to various embodiments of the present disclosure, the negative response to the query may be received as at least one external device cannot process the query or received by the processor 220 as a signal that informs that the query cannot be processed by a module of the electronic device 200.

The command processing module 221 may determine whether the data input through the input/output module 230 is the user input and identify whether the user input can be processed by the electronic device 200. For example, the command processing module 221 may identify whether the input data includes command data for performing a particular function or data indicating a task, and determine whether the electronic device 200 includes an element or data required for performing the command data or the task.

According to various embodiments of the present disclosure, the command processing module 221 may deduce a user's intent from the user input. For example, when predetermined data is input, the command processing module 221 may determine the corresponding data as a first intent. Data processing schemes for determining the intent may include at least one of a natural language process, a knowledge base, and artificial intelligence, and there may be also various schemes for determining a task or a user's intent through input data.

According to various embodiments of the present disclosure, the command processing module 221 may generate a query based on a result of the data processing. For example, the query may include data that makes a request for extracting or identifying particular information from a database or performing a function of determining user characteristics (for example, taste, tendency, or context).

When the user input cannot be processed, the handoff processing module 222 may transmit input data corresponding to the user input to an external electronic device and make a control to request processing of the input data.

According to various embodiments of the present disclosure, as the handoff is performed, a particular external electronic device may execute a voice recognition application, process the handed off data as input data of the voice recognition application, and transmit a query including the input data to the server. The external electronic device may output a result of the processing of the input data corresponding to the query or transmit the result to the electronic device 200.

The sensor control module 223 may identify sensors included in the electronic device 200 and may convert data measured by the sensors into data which can be processed by the electronic device 200. For example, the sensors may include at least one sensor included in external electronic devices performing short range communication with the electronic device 200.

According to various embodiments of the present disclosure, when the query (for example, measuring a heart-rate) includes a task related to sensing sensor data, the sensor control module 223 may control the sensor module 250 to acquire sensor data of a particular sensor.

The input/output module 230 may include various circuitry to input or output a user input and may include various circuitry, such as, for example, and without limitation, a microphone (not shown), a speaker (not shown), and a display (not shown) for inputting or outputting the user input.

According to various embodiments of the present disclosure, the data input through the input/output module 230 may be processed by the external electronic device and the processing result may be output again through the input/output module 230. For example, the processing operation may include an operation of transmitting a query request including task information corresponding to the input data to the server and receiving and outputting a response to the query request.

The memory 240 may store local user data, user data, local data, or sensor information.

The local user information may correspond to information related to the user of the electronic device 200 and may include personal information of the user, a schedule, and contact information.

The user information may correspond to information for managing each electronic device by the server and may include account information on a connection of the electronic device 200.

The local information may correspond to information on the electronic device 200 and may include a module, a program, and system information of the electronic device 200. For example, the electronic device 200 may identify the module, the program, and the system information of the electronic device 200 related to a particular query based on the local information.

The sensor information may include sensors included in the electronic device 200 and data information which can be measured by each sensor.

According to various embodiments of the present disclosure, the memory 240 may store information on an external electronic device in order to perform the handoff of the query to the external electronic device. For example, based on at least some of the information on the external electronic device, the electronic device 200 may determine at least one external electronic device which can process the corresponding query.

The sensor module 250 may include at least one sensor and may detect data in various forms through the at least one sensor. For example, the detected data may be measured in the form of text, voice, or acceleration information, and the measured data may be processed by the electronic device 200 as a motion, a command, or biometric information of the user.

An electronic device according to various embodiments of the present disclosure may include: at least one communication module; and a processor, wherein the processor may generate a first query based on a user input, identify a response to the first query, and transmit a second query generated at least based on the first query to an external electronic device, which can perform short-range communication, through the at least one communication module based on a result of the response to make the second query processed by the external electronic device.

The processor according to various embodiments of the present disclosure may make a control to transmit the first query to a server through the external electronic device and receive the response from the server through the external electronic device.

The processor according to various embodiments of the present disclosure may perform an operation of making a control to not transmit the second query when the result meets a first precondition and perform an operation of making a control to transmit the second query when the result meets a second precondition.

The at least one communication module of the electronic device according to various embodiments of the present disclosure may include a first communication module and a second communication module, and the processor may receive the first response from another external electronic device through the first communication module and transmit the second query to the external electronic device through the second communication module.

The processor according to various embodiments of the present disclosure may select at least one external electronic device, which can process the second query, among the external electronic devices as the external electronic device at least based on the result.

The processor according to various embodiments of the present disclosure may receive another response to the second query from the external electronic device and provide the other response through an output device functionally connected to the processor.

The processor according to various embodiments of the present disclosure may receive another response to a part of the second query from the external electronic device and process another part of the second query at least based on the other response.

The processor according to various embodiments of the present disclosure may identify at least one operation related to a task, identify at least one external electronic device which can perform the at least one operation, respectively, and transmit information on the at least one operation which can be processed by the corresponding electronic devices to the at least one identified external electronic devices, respectively.

The processor according to various embodiments of the present disclosure may receive an indication indicating whether the second query can be processed by the external electronic device from a server.

The electronic device according to various embodiments of the present disclosure may further include a microphone, and the processor may acquire a voice input of a user corresponding to the electronic device as at least a part of the user input and identify data corresponding to the acquired voice input as the query.

The processor according to various embodiments of the present disclosure may acquire a text input as at least a part of the user input and identify data corresponding to the acquired text input as the query.

The processor according to various embodiments of the present disclosure may generate another query at least based on the first query, identify a task to be performed in connection with the other query, make a control to not transmit the other query when the result meets a first precondition, and make a control to transmit the other query to the external electronic device through the communication module when the result meets a second precondition.

The processor according to various embodiments of the present disclosure may transmit the other query to another external electronic device, receive information on the task from the other external electronic device as a response to the other query, and transmit at least a part of the query to the external electronic device at least based on the result.

According to various embodiments of the present disclosure, the task may include an operation related to electronic payment, and the processor may identify an external electronic device including a module for performing the operation related to the electronic payment among the at least one external electronic device and select the identified external electronic device as an external electronic device which can perform the task.

An electronic device according to various embodiments of the present disclosure may include: a communication module; and a processor, wherein the processor may acquire a query from a user corresponding to the electronic device, identify a data domain corresponding to a task to be performed in connection with the query, determine whether an external electronic device corresponding to the user can perform the task at least based on the data domain, and transmit at least a part of the query or a response to the query to the external electronic device through the communication module at least based on the determination that the external electronic device can perform the task.

The processor according to various embodiments of the present disclosure may receive state information of the external electronic device from another external electronic device and determine whether the task can be performed further based on the state information.

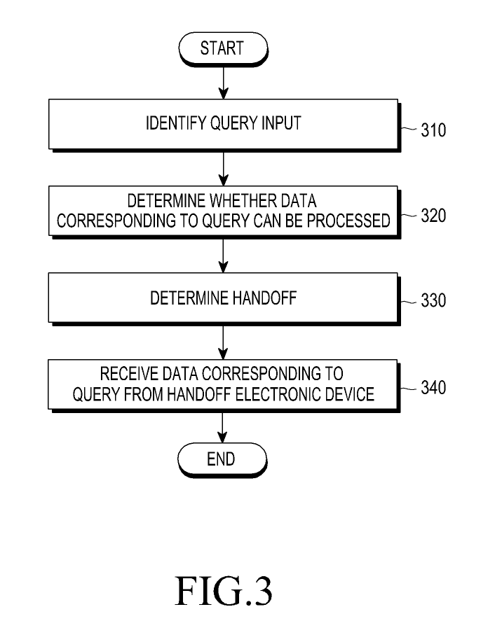

FIG. 3 is a flowchart illustrating an example of an operation of processing a user input by an electronic device according to various example embodiments of the present disclosure.

Referring to FIG. 3, in operation 310, the electronic device may identify whether a query is input. For example, the query may be received in the form of voice data or text data through the input/output interface of the electronic device.

In operation 320, the electronic device (for example, the command processing module 221) may determine whether data corresponding to the query can be processed. For example, the electronic device may identify a task corresponding to the query and determine whether a data domain related to the task can be identified. The data domain may include operations defined to perform a particular task and information on a relationship between the operations.

In operation 330, the electronic device (for example, the handoff processing module 222) may determine a handoff. For example, the electronic device may identify functions or state information of external electronic devices, transmit the query to at least one electronic device, which can process the query, and make a request for processing the query.

In operation 340, the electronic device (for example, the communication module 210) may receive data corresponding to the query from the handoff electronic device. For example, the data corresponding to the query may include a result of processing of the task corresponding to the query by the handoff electronic device.

A method of processing a user input by an electronic device may include: an operation of acquiring a query from a user corresponding to the electronic device; an operation of identifying a data domain corresponding to a task to be performed in connection with the query; an operation of determining whether an external electronic device corresponding to the user can perform the task at least based on the data domain; and an operation of transmitting at least a part of the query or a response to the query to the external electronic device through the communication module at least based on the determination that the external electronic device can perform the task.

The method of processing the user input by the electronic device according to various embodiments of the present disclosure may further include: an operation of receiving state information of the external electronic device from another external electronic device; and an operation of determining whether the external electronic device can perform the task further based on the state information.

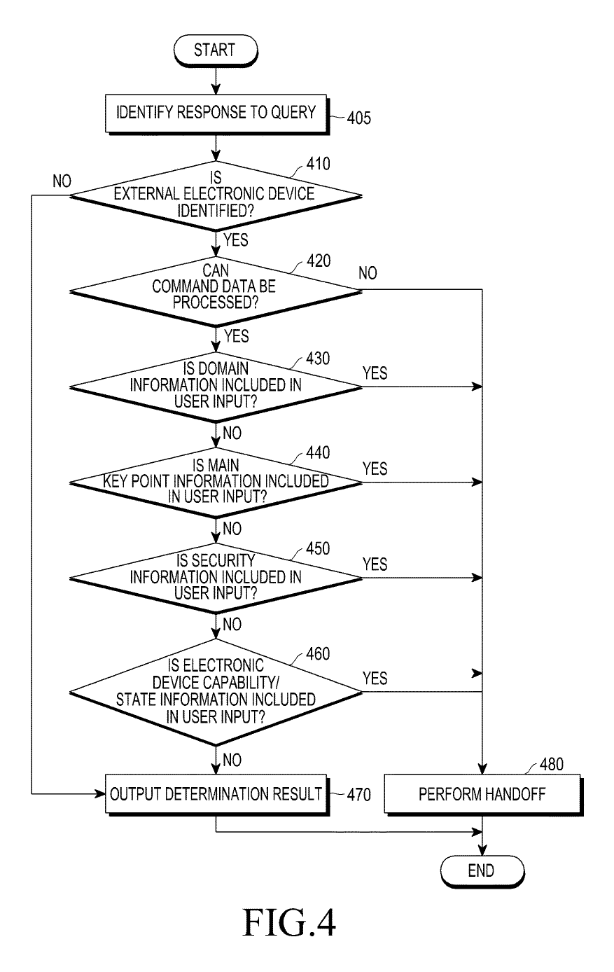

FIG. 4 is a flowchart illustrating an example of an operation of performing a handoff to an external electronic device based on whether an electronic device can process a user input according to various example embodiments of the present disclosure.

The orders of operations of FIG. 4 described below may be changed or at least one configuration may be changed or omitted.

Referring to FIG. 4, in operation 405 may identify a response to a query. In operation 410, the electronic device (for example, the processor 220) may determine whether there is at least one electronic device which can perform an operation related to a user input.

When at least one electronic device is not found based on a result of the performance of operation 410, the electronic device (for example, the processor 220) may output a negative response as a result of the determination of the user input in operation 470. For example, the negative response may include information that informs a user that a user response cannot be determined or cannot be processed.

When at least one electronic device is found based on the result of the performance of operation 410, the electronic device (for example, the processor 220) may identify whether command data corresponding to the received user input can be processed in operation 420. For example, the command data may include information that makes a command to measure data through a sensor or a module of the electronic device.

When the command data can be processed based on a result of the performance of operation 420, the electronic device (for example, the processor 220) may determine whether the user input includes domain information in operation 430. For example, the domain information may include operations required for performing a particular command and information on orders between the operations.

According to various embodiments of the present disclosure, the electronic device may identify at least some information which can be performed by an external electronic device among the domain information based on the domain information and transmit information (for example, command data) required for performing some domain information to the corresponding external electronic device.

When the user input does not include the domain information based on a result of the performance of operation 430, the electronic device (for example, the processor 220) may determine whether the user input includes main key point information in operation 440. For example, the key point information corresponds to information on the electronic device that performs an operation related to the domain and may include identification information of the corresponding electronic device and operation order information between electronic devices.

When the key point information is not found based on a result of the performance of operation 440, the electronic device (for example, the processor 220) may determine whether the user input includes security information in operation 450.

When the user input does not include the security information based on a result of the performance of operation 450, the electronic device (for example, the processor 220) may determine whether information related to a capability or a state of at least one identified electronic device is included in the user input in operation 460.

When the information related to the capability or the state of the electronic device is not included in the user input based on a result of the performance of operation 460, the electronic device (for example, the processor 220) may output a negative response as a result of the determination of the user input in operation 470. For example, the negative response may include information that informs a user that a user response cannot be determined or cannot be processed.

When the command data cannot be processed by the electronic device based on the result of the performance of operation 420 or when the user input includes at least one of domain information, key point information, security information, and the capability and state information of the electronic device based on the result of the performance of operations 430, 440, 450, and 460, the electronic device (for example, the processor 220) may perform a handoff operation to allow the electronic device which can process the identified information among at least one identified electronic device to process the user input in operation 480.

According to various embodiments of the present disclosure, the electronic device may determine an electronic device, which can process a predetermined number of pieces of information among the aforementioned information or information having a high priority based on a predetermined priority as the electronic device to which the handoff is performed.

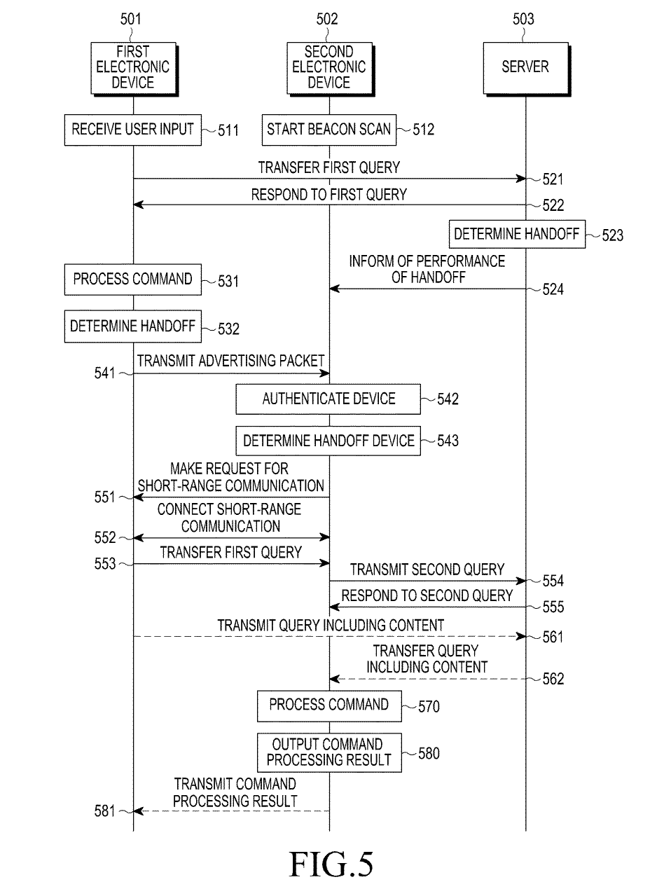

FIG. 5 is a flowchart illustrating an example of an operation for processing a user input between at least one electronic device and a server according to various example embodiments of the present disclosure.

Referring to FIG. 5, at least one electronic device (for example, a first electronic device 501 or a second electronic device 502) and a server 503 may identify a user input and an electronic device which can process the identified user input.

In operation 511, the first electronic device 501 may receive the user input.

In operation 512, the second electronic device 502 may start an operation of scanning for a beacon on every predetermined period.

According to various embodiments of the present disclosure, although the beacon is scanned for in operation 512, the second electronic device 502 may be set to scan for the beacon at a predetermined time point or on every period.

In operation 521, the first electronic device 501 may transmit a first query for the user input to the server 503.

According to various embodiments of the present disclosure, the first electronic device 501 may be configured to identify a task related to the first query and to process the task. For example, the first electronic device 501 may receive information for processing the first query from the server 503 or perform the task related to the first query by a module included in the first electronic device 501.

In operation 522, the server 503 may identify command data corresponding to the first query and transmit the command data to the first electronic device 501 as a response to the first query.

In operation 531, the first electronic device 501 may identify the command data in the response to the first query and process the identified command.

When the response to the first query is a negative response, the first electronic device 501 may determine a handoff in operation 532. For example, when the first query cannot be processed by the first electronic device 501 or when task information related to the first query is not identified, the server 503 may transmit the negative response to the first electronic device 501 as the response to the first query.

In operation 524, the server 503 may inform the second electronic device 502 whether to perform the handoff.

In operation 541, the first electronic device 501 may transmit an advertising packet. For example, the advertising packet may include a query and domain information.

When the advertising packet is scanned for based on a result of the performance of operation 512, the second electronic device 502 may authenticate the device in operation 542. For example, an operation for authenticating the device may include an operation in which information on the second electronic device 502 is transmitted to the first electronic device 501, first electronic device 501 receives an acknowledgement response to the information on the second electronic device 502, and the first electronic device 501 and the second electronic device 502 are connected to each other.

In operation 543, the second electronic device 502 may identify that the second electronic device 502 is determined as a handoff device. For example, when the second electronic device 502 is selected as the handoff device by the user through the first electronic device 501, a message that informs that the second electronic device 502 is selected as the handoff device may be transmitted from the first electronic device 502.

In operation 551, the second electronic device 502 may transmit a message that makes a request for short-range communication to the first electronic device 501.

In operation 552, in response to the transmitted request for short-range communication, the first electronic device 501 and the second electronic device 502 may be connected through short-range communication.

In operation 553, the first electronic device 501 may transfer a first query to the second electronic device 502. For example, the first query may include command data of which the negative response is received from the server 503, and the first electronic device 501 may transmit the first query to the second electronic device 502 through short-range communication.

According to various embodiments of the present disclosure, the first query transmitted to the second electronic device 502 is transmitted to the second electronic device 502 as the first query cannot be processed by the first electronic device 502, and may include a part of the task in the query which can be processed by the second electronic device 502.

According to various embodiments of the present disclosure, the transmitted first query may include the user input, a response to the first query, or a result of the performance of the first query.

In operation 554, the second electronic device 502 may transmit a second query to the server 503. For example, the second query may include the user input included in the first query.

In operation 555, the server 503 may transmit a response to the second query to the second electronic device 502. For example, the response to the second query may include command data corresponding to the second query and information on a task or an operation which can be processed by the second electronic device 502, and further include information on a sensor or a module required for performing the task or the operation.

In operation 561, the first electronic device 501 may transmit a query including a content to the server 503.

When the server 503 receives the query including the content, the server may output the content or may identify the electronic device storing the content and transmit the query including the content to the corresponding electronic device (for example, the second electronic device 502) in operation 562.

In operation 570, the second electronic device 502 may identify the response to the second query or the command data included in the transmitted query including the content, and process the command data. For example, the command data may include information on a particular configuration (for example, a module or a sensor) and further include information on a command for receiving data from the corresponding configuration or controlling the corresponding configuration.

In operation 580, the second electronic device 502 may output a result of the processing of the command data. For example, the second electronic device 502 may output data, which informs that the command data is completely processed, the processing of the command data fails, or the command data is being processed, and the output data may have various forms such as voice data, image data, or text data.

In operation 581, the second electronic device 502 may transmit the command processing result to the first electronic device 501. For example, the second electronic device 502 may transmit the data that informs of success or failure of the processing of the command data to the first electronic device 501.

According to various embodiments of the present disclosure, when the second electronic device 502 completely processes particular command data, operation 581 described above may be omitted.

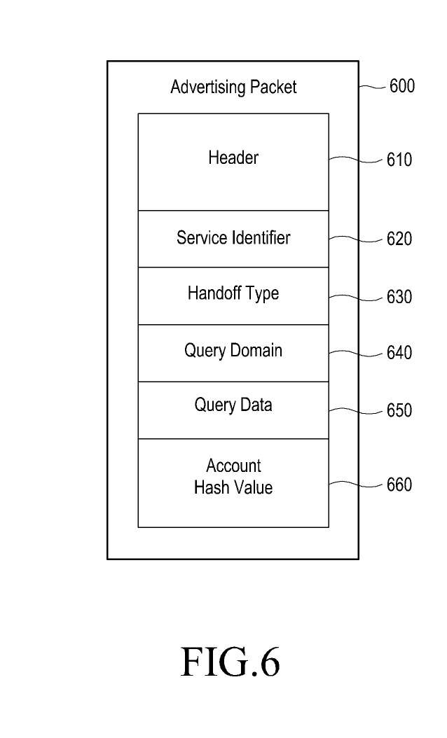

FIG. 6 is a block diagram illustrating an example of an advertising packet structure transmitted by an electronic device to discover a handoff electronic device according to various example embodiments of the present disclosure.

Referring to FIG. 6, an advertising packet 600 may include, for example, a header 610, a service identifier 620, a handoff type 630, a query domain 640, query data 650, or an account hash value 660.

According to various embodiments of the present disclosure, the advertising packet 600 may be transmitted by electronic devices (for example, the first to third electronic devices 101, 102, and 104) to identify at least one external electronic device to which a query will be transmitted. For example, the electronic device may receive the advertising packet 600 or an acknowledgement response to the advertising packet 600 and identify the electronic device that has transmitted the advertising packet 600 or the acknowledgement response as the external electronic device.

The header 610 may indicate whether information related to the handoff is included.

The service identifier 620 may include identification information of a service (for example, a handoff) to be performed using the advertising packet 600.

The handoff type 630 may include task information for performing the handoff (for example, execution of a voice recognition application).

The query domain 640 may include information on a command related to a user input (for example, measurement of health information).

The query data 650 may include a value of the command data.

The account hash value 660 may include account information related to the electronic device having transmitted the advertising packet 600.

According to various embodiments of the present disclosure, the electronic device having received the advertising packet 600 may identify account information of the first electronic device by checking the account hash value 660 and identify the electronic device that share common account information with the first electronic device through the account information.

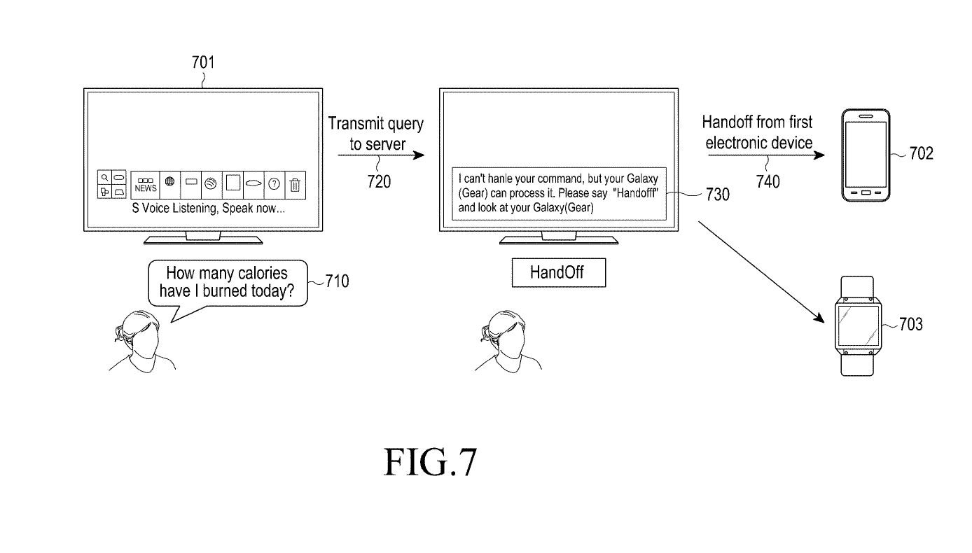

FIG. 7 is a diagram illustrating an example of a situation in which an electronic device performs a handoff based on a user input according to various example embodiments of the present disclosure.

Referring to FIG. 7, an electronic device 701 may execute a voice recognition application. For example, the voice recognition application may identify received user's voice data and execute a command corresponding to the voice data through the electronic device 701.

According to various embodiments of the present disclosure, in order to identify the number of burned calories for a day through the electronic device 701, the user may make a user input that inquires about how many calories have been burned (“how many calories have I burned today”) in the form of voice data in operation 710.

In operation 720, the electronic device 701 may transmit a query that inquires about a command related to the user input to the server.

In operation 730, the server may transmit a negative response to the query to the electronic device 701. For example, the negative response may include data which informs the user that command data related to the user input cannot be identified or that the user input cannot be identified.

According to various embodiments of the present disclosure, when the command data related to the user input cannot be identified, the server may make a request for processing of a task that processes the user input by another electronic device to an external electronic device of the electronic device 701.

According to various embodiments of the present disclosure, the user may input a handoff command (for example, “handoff”) through the electronic device 701 and identify at least one external electronic device to which the handoff is performed according to the user's handoff command.

According to various embodiments of the present disclosure, when the electronic device 701 cannot process the command data, the electronic device 701 may transmit a task of processing the user input to another electronic device and output data that inquiries whether to make a request for processing the input data. For example, as the user inputs an acknowledgement response to the data or a predetermined time passes, the task for processing the user input may be transmitted to another electronic device.

In operation 740, the electronic device 701 may transmit the user input to another electronic device (for example, the first electronic device 702) and make a request for processing the input data.

According to various embodiments of the present disclosure, the electronic device 701 may scan for at least one external electronic device (for example, the first electronic device 702 or the second electronic device 703) and identify the electronic device which can measure health information (for example, the number of burned calories) as the handoff electronic device based on command data of the user input. For example, the electronic device 701 may identify the electronic device including a sensor that detects user's motion, blood pressure, biometric information, or heart-rate as a part of the health information as the electronic device which can measure the health information.

According to various embodiments of the present disclosure, the electronic device 701 may identify measurement of user's motion data as the data related to the burned calories and identify the electronic device (for example, the first electronic device 702) including an acceleration sensor that detects the user's motion. For example, the first electronic device 702 includes the acceleration sensor, and may measure the user's motion detected for a predetermined time through the data measured through the acceleration sensor as the part of the health information.

According to various embodiments of the present disclosure, the electronic device 701 may be handed off to the electronic device (for example, the first electronic device 702) which can process the command data corresponding to the user input, and the corresponding electronic device can process the command data corresponding to the user input. Accordingly, the user can process the command data through the electronic device, which can process the command data, without re-inputting the command data, which cannot be processed by the electronic device 701, into another electronic device.

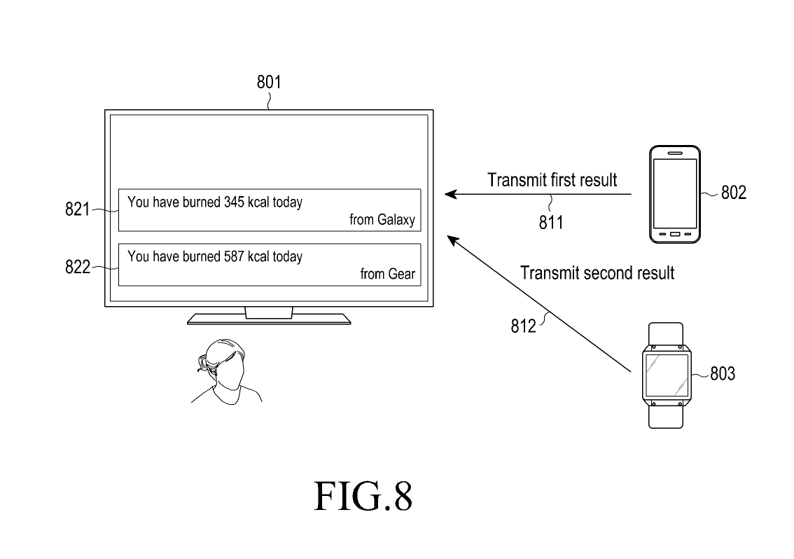

FIG. 8 is a diagram illustrating an example of a situation in which a result of performance of a user input is identified through a handoff electronic device according to various example embodiments of the present disclosure.

Referring to FIG. 8, an electronic device (for example, a smart TV) 801 may execute a voice recognition application. For example, the voice recognition application may identify received user's voice data and execute a command corresponding to the voice data through the electronic device 801.

According to various embodiments of the present disclosure, the voice data may include the content that makes a request for identifying burned calories for a day, and a task corresponding to the voice data may include an operation for measuring a user's motion detected through a sensor of the electronic device 801 and determining a value of the measured motion as burned calories.

According to various embodiments of the present disclosure, when the electronic device 801 cannot process a command corresponding to the received voice data, a task for processing the command may be handed off from the electronic device 801 to at least one electronic device (for example, the first electronic device 802 (for example, smart phone) or the second electronic device 803 (for example, wearable device).

In operation 811, the first electronic device 802 may execute the command corresponding to the voice data and transmit the result of the performance of the command to the electronic device 801 as a first result. For example, the first electronic device 802 may identify data measured as the user's motion and determine burned calories as 345 calories based on the identified data.

In operation 812, the second electronic device 803 may execute the command corresponding to the voice data and transmit the result of the performance of the command to the electronic device 801 as a second result. For example, the second electronic device 803 may identify data measured as the user's motion and determine the number of burned calories as 587 calories based on the identified data.

According to various embodiments of the present disclosure, the electronic device 801 may receive the result of the performance of the command from the handoff electronic devices (for example, the first electronic device 802 or the second electronic device 803) and output the result through the display, e.g., messages 821 and 822. The user may make a user input into the electronic device 801 and identify, through the electronic device 801, a result of the user input processed in another electronic device.

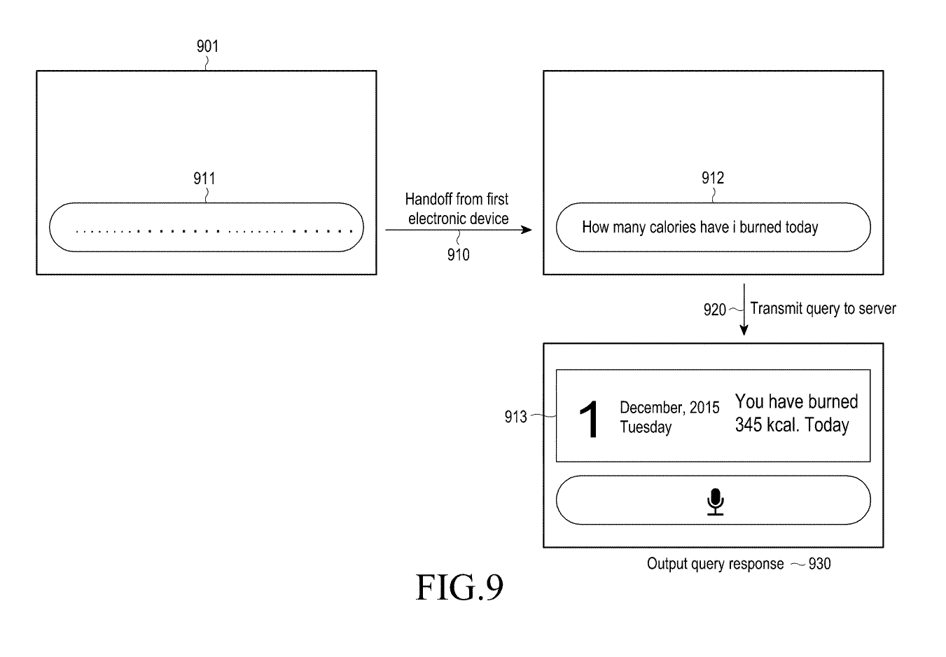

FIG. 9 is a diagram illustrating an example of a situation in which an electronic device performs a handoff according to a user input and outputs a result of the performance according to various example embodiments of the present disclosure.

Referring to FIG. 9, the electronic device (for example, a smart TV) may execute a voice recognition application and an execution screen 901 of the voice recognition application may include an indication 911 which informs that voice data can be input.

In operation 910, the electronic device may be handed off from the first electronic device. For example, as the first electronic device cannot process voice data, the processing of the voice data can be handed off to the electronic device.

According to various embodiments of the present disclosure, the electronic device may identify a query corresponding to the voice data and output the query to the execution screen 901. For example, the query may include data (for example, “How many calories have I burned today”) 912 that makes a request for identifying the number of burned calories.

According to various embodiments of the present disclosure, when the user inputs the query that makes the request for identifying the number of burned calories through voice data, the electronic device may perform a handoff according to whether the query can be processed. For example, when the query cannot be processed, the handoff may include an operation of switching a subject of the operation for processing query from the electronic device to the first electronic device.

According to various embodiments of the present disclosure, the first electronic device may be handed off from the electronic device as the first electronic device includes a sensor that can measure a user's motion. For example, the first electronic device may determine the number of burned calories of the user based on measured data and transmit the determined number of calorie information to the electronic device.

In operation 920, the electronic device may transmit the query with the handed off voice data to the server.

According to various embodiments of the present disclosure, the electronic device may receive a response to the equerry from the first electronic device. For example, the response to the query may include task information (for example, determination of the number of burned calories) corresponding to the query, which is transmitted to the server by the first electronic device, the task information being received from the server in response to the transmission of the query.

In operation 930, the electronic device may output a response to the query received from the first electronic device. For example, the response to the query may include data (for example, “You have burned 345 kcal. today”) 913 indicating the measured number of burned calories as a result of the processing of the task.

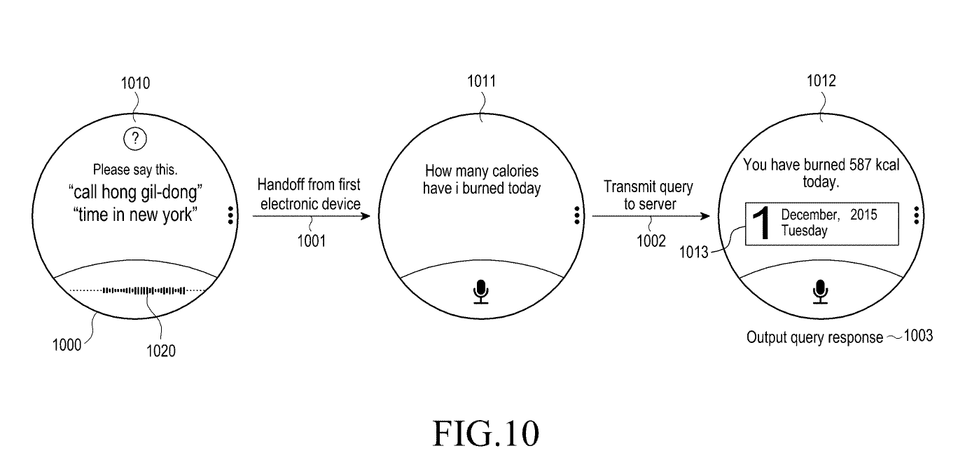

FIG. 10 is a diagram illustrating an example of a situation in which a query handed off from an external electronic device is processed according to various example embodiments of the present disclosure.

Referring to FIG. 10, an electronic device (for example, a wearable device) may execute a voice recognition application, and various operations corresponding to a made user input may be performed through the voice recognition application.

According to various embodiments of the present disclosure, the voice recognition application may be executed according to the handoff from the first electronic device. For example, as a first electronic device (for example, smart TV) receives a query which cannot be processed, the query may be handed off to the electronic device.

An execution screen 1000 of the voice recognition application may include an example 1010 of voice data, which can be input, or an indication 1020 indicating that voice data can be input.

In operation 1001, the electronic device may be handed off from the first electronic device.

According to various embodiments of the present disclosure, the execution screen 1000 of the voice recognition application may output a user input (for example, “How many calories have I burned today”) received according to the handoff in the form of text data.

In operation 1002, the electronic device may transmit a query corresponding to the user input to the server. For example, the query corresponding to the user input may be a request for measuring a user's motion for a predetermined time through at least one sensor.

In operation 1003, the electronic device may output a response corresponding to the transmitted query through text or image data. For example, the response corresponding to the query may include time information at the moment when burned calories are measured (for example, “1 Dec. 2015 Tuesday”) and information on burned calories corresponding to the measured user's motion (for example, “You have burned 587 kcal. today”) 1012.

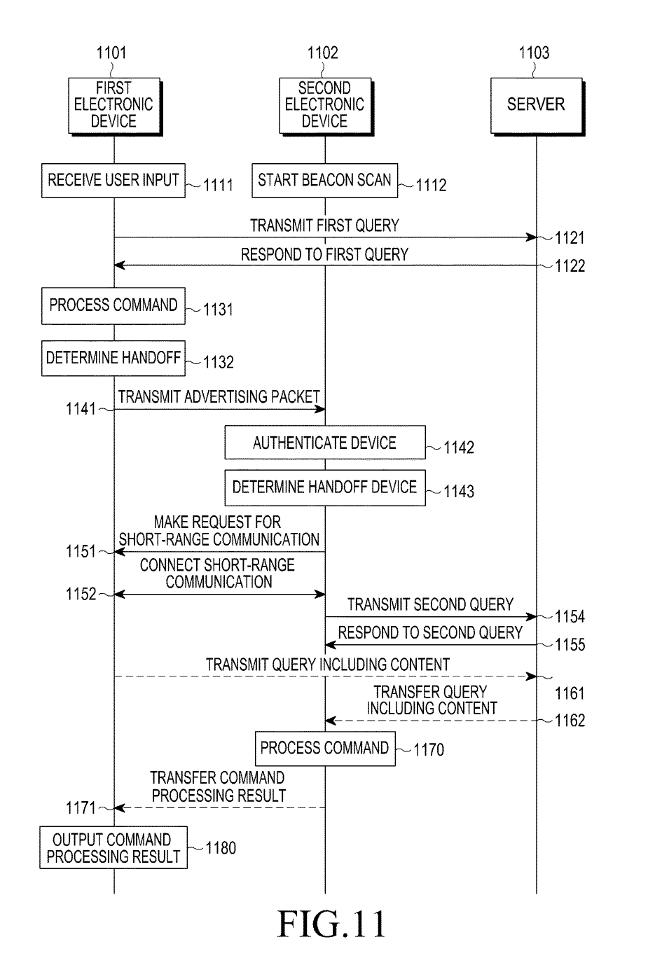

FIG. 11 is a diagram illustrating an example of an operation in which a user input between at least one electronic device and a server is processed according to various example embodiments of the present disclosure.

Referring to FIG. 11, at least one electronic device (for example, a first electronic device 1101 or a second electronic device 1102) and a server 1103 may identify a user input and identify an electronic device which can process the identified user input.

In operation 1111, the first electronic device 1101 may receive the user input.

In operation 1112, the second electronic device 1102 may start a beacon scan operation for scanning for a beacon at every predetermined period.

In operation 1121, the first electronic device 1101 may transmit a first query for the user input to the server 1103.

In operation 1122, the server 1103 may identify command data corresponding to the first query and transmit the command data to the first electronic device 1101 as a response to the first query.

In operation 1131, the first electronic device 1101 may identify the command data in the response to the first query and process the identified command.

When the response to the first query is a negative response, the first electronic device 1101 may determine a handoff in operation 1132. For example, when the first query cannot be processed by the first electronic device 1101 or when task information related to the first query is not identified, the server 1103 may transmit the negative response to the first electronic device 1101 as the response to the first query.

In operation 1141, the first electronic device 1101 may transmit an advertising packet. For example, the advertising packet may include a query and domain information.

When the advertising packet is scanned for based on a result of the performance of operation 1112, the second electronic device 1102 may authenticate the device in operation 1142. For example, an operation for authenticating the device may include an operation in which information on the second electronic device 1102 is transmitted to the first electronic device 1101, the first electronic device 1101 receives an acknowledgement response to the information on the second electronic device 1002, and the first electronic device 1101 and the second electronic device 1102 are connected to each other.

In operation 1143, the second electronic device 1102 may identify that the second electronic device 1102 is determined as a handoff device. For example, when the second electronic device 1102 is selected as the handoff device by the user through the first electronic device 1101, a message that informs that the second electronic device 1102 is selected as the handoff device may be transmitted from the first electronic device 1101.

In operation 1151, the second electronic device 1102 may transmit a message that makes a request for short-range communication to the first electronic device 1101.

In operation 1152, in response to the transmitted request for short-range communication, the first electronic device 1101 and the second electronic device 1102 may be connected through short-range communication.

In operation 1154, the second electronic device 1102 may transmit a second query to the server 1103. For example, the second query may include the user input included in the first query.

According to various embodiments of the present disclosure, the transmitted second query may include the user input, a response to the first query, or a result of the performance of the first query.

In operation 1155, the server 1103 may transmit a response to the second query to the second electronic device 1102. For example, the response to the second query may include command data corresponding to the second query and information on a task or an operation which can be processed by the second electronic device 1102, and further include information on a sensor or a module required for performing the task or the operation.

In operation 1161, the first electronic device 1101 may transmit a query including a content to the server 1103.

When the server 1103 receives the query including the content, the server 1103 may output the content or may identify the electronic device storing the content and transmit the query including the content to the corresponding electronic device (for example, the second electronic device 1102) in operation 1162.

In operation 1170, the second electronic device 1102 may identify the response to the second query or the command data included in the transmitted query including the content, and process the command data. For example, the command data may include information on a particular configuration (for example, a module or a sensor) and further include information on a command for receiving data from the corresponding configuration or controlling the corresponding configuration.

In operation 1171, the second electronic device 1102 may transmit a result of the processing of the command to the first electronic device 1101 having received the user input.

In operation 1180, the first electronic device 1101 may output the result of the processing of the command data. For example, the result of the processing of the command data may include the fact that a task corresponding to the user input is performed and a value of a result of the performance of the task, and the output data may have various forms such as voice data, image data, or text data.

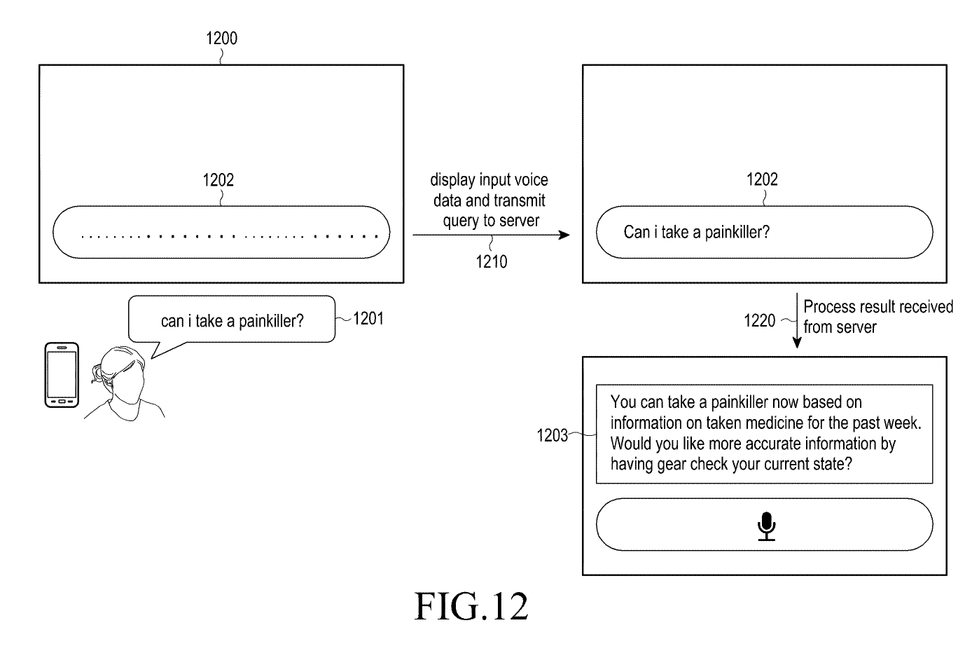

FIG. 12 is a diagram illustrating an example of a situation in which an electronic device processes a user input according to various example embodiments of the present disclosure.

Referring to FIG. 12, the electronic device may execute a voice recognition application. An execution screen 1200 of the voice recognition application may include an area 1202 which informs that voice data of the user can be input or to which voice data input by the user is output.

According to various embodiments of the present disclosure, the user may input a query that inquires about whether medicine can be taken in the form of voice data (for example, “can I take a painkiller”) 1201 through the electronic device.

In operation 1210, the electronic device may display the input voice data and transmit a query corresponding to the voice data to the server.

In operation 1220, the electronic device may receive a response to the query 1202 from the server and identify the received response as a result 1203 of processing of the user input.

According to various embodiments of the present disclosure, the processing result 1203 may be displayed on the execution screen 1200 of the voice recognition application. For example, the processing result 1203 may include information related to taking a painkiller (for example, “You can take a painkiller now based on information on taken medicine for the past week”) or data that inquires about whether to acquire the information related to taking the painkiller (for example, “Would you like more accurate information by having Gear check your current state?”) from another electronic device (for example, wearable device).

According to various embodiments of the present disclosure the gear corresponds to a wearable device and may be a device which the user can wear in the form of a clock.

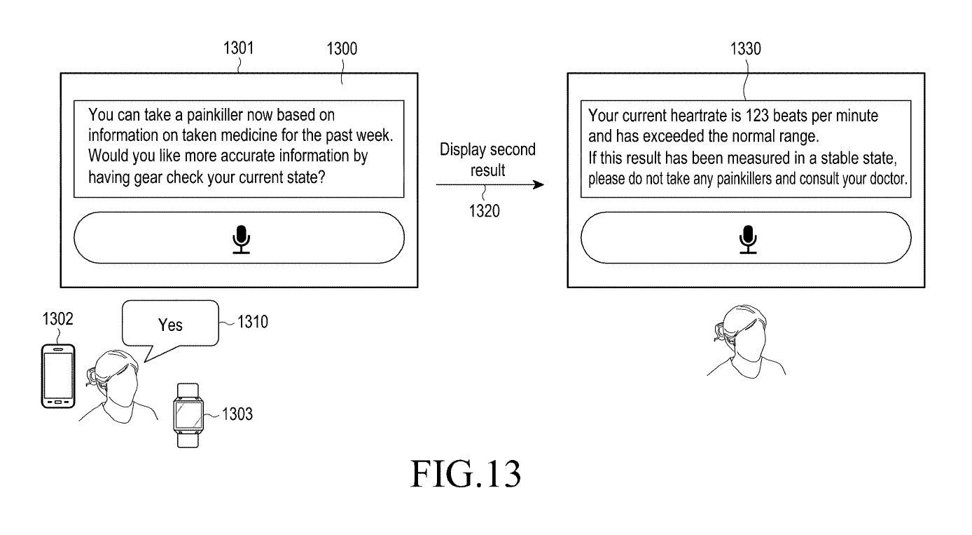

FIG. 13 is a diagram illustrating an example of a situation in which an electronic device inquiries about whether to perform a handoff based on a user input according to various example embodiments of the present disclosure.

Referring to FIG. 13, the electronic device 1301 may execute a voice recognition application. An execution screen 1300 of the voice recognition application may include a response to a query corresponding to the user input received from the server as a result 1300 of processing of the user input. For example, the processing result 1300 may include information related to taking a painkiller (for example, “You can take a painkiller now based on information on taken medicine for the past week.”) or data that inquires about whether to acquire the information related to taking the painkiller (for example, “Would you like more accurate information by having Gear check your current state?”) from another electronic device (for example, a wearable device).

According to various embodiments of the present disclosure, the electronic device may transmit an advertising packet and hand off the query to at least one electronic device (for example, a first electronic device 1302 or a second electronic device 1303) that responds to the transmitted packet. For example, the electronic device may determine to perform the handoff as the user inputs a positive response (for example “yes”) 1310 as a response corresponding to a processing result 1300.

According to various embodiments of the present disclosure, the electronic device may transmit the query to at least one electronic device (for example, the first electronic device 1302 or the second electronic device 1303) and receive the response to the query from the at least one electronic device. For example, the query may include command data that makes a request for measuring user's health information, and the second electronic device 1303 may transmit data measured as heart-rate information to the electronic device as the response to the query.

According to various embodiments of the present disclosure, when the electronic device receives the measured heart-rate information from the second electronic device 1303, in operation 1320, the electronic device may reflect the received information and display the processing result 1300 as a second result. For example, the processing result 1330 in which the received information is reflected may include heart-rate information (for example, “Your current heart-rate is 123 beats per minute and has exceeded the normal range”) and information on taking a painkiller in which the heart-rate information is reflected (for example, “If this result has been measured in a stable state, please do not take any painkillers and consult your doctor”).

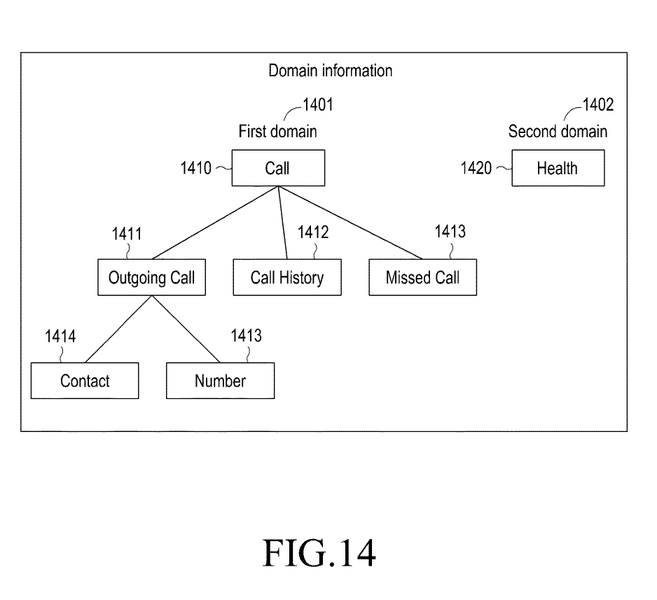

FIG. 14 is a block diagram illustrating an example of a domain information structure according to various example embodiments of the present disclosure.

Referring to FIG. 14, domain information may include at least one domain (for example, a first domain 1401 or a second domain 1402).

The first domain 1401 may include data for performing a task for call application execution (call) 1410. Data required for performing the task for call application execution 1410 may include data on an outgoing call 1411, a call history 1412, or a missed call 1143. The outgoing call 1411 may include data required for performing the call including contact 1414 and number 1413.

The second domain 1402 may include data for performing a command of a task for health information collection (health) 1420.

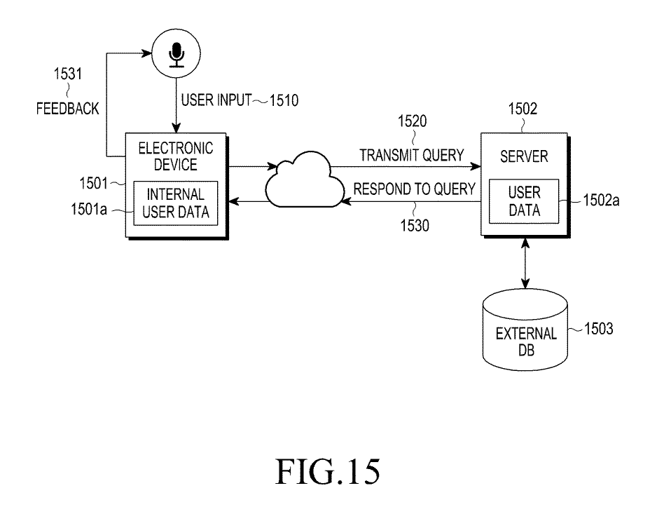

FIG. 15 is a diagram illustrating an example of a configuration of a system for processing a user input according to various embodiments of the present disclosure.

Referring to FIG. 15, the system may include an electronic device 1501 or a server 1502, and the server 1502 may include an external DB 1503 or be electrically connected to the external DB 1503 to identify user information.

The electronic device 1501 may store internal user data 1501a. For example, the internal user data 1501a may include information related to the user which is input through the electronic device 1501 such as personal information and schedule information of the user of the electronic device 1501.

The server 1502 may store user data 1502a. For example, the user data 1502a corresponds to information on an account and may include at least one account and identification information of the electronic device related to the corresponding account.

In operation 1510, the electronic device 1501 may identify that a user input is made. For example, the user input may be input through an input/output interface of the electronic device 1501 or may be data input as the query, which is received from an external electronic device, as the query is handed off from the external electronic device.

In operation 1520, the electronic device 1501 may transmit the query for the made user input to the server 1502. For example, the query may include at least some of the internal user data 1501a and make a request for identifying a task related to the user input.

In operation 1530, the server 1502 may transmit a response to the query to the electronic device 1501. For example, the response to the query may include information on the task which can be performed using the internal user data 1501a

In operation 1531, the electronic device 1501 may identify the response to the query as feedback of the user input.

According to various embodiments of the present disclosure, data on the feedback may be output through an input/output interface or processed as the task performed by the electronic device 1501.

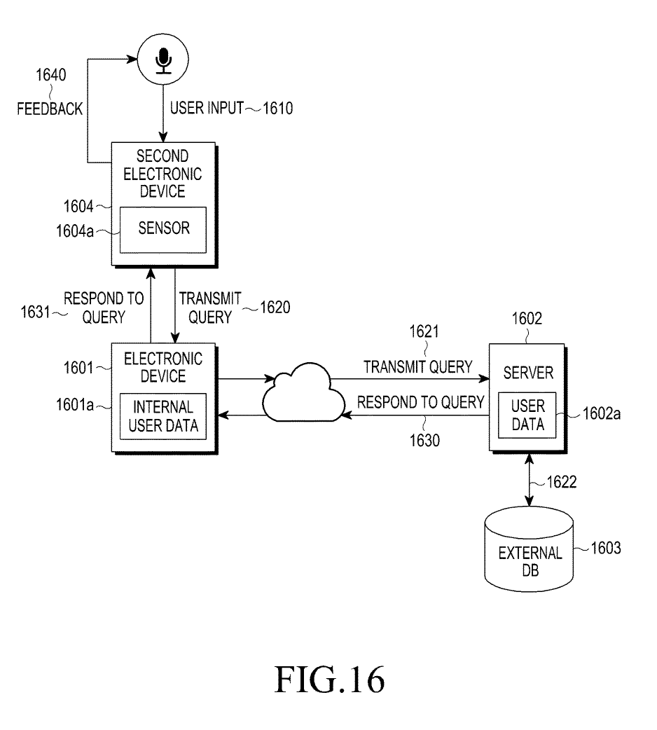

FIG. 16 is a diagram illustrating an example of a configuration of a system that processes a user input according to various example embodiments of the present disclosure.

Referring to FIG. 16, the system may include a first electronic device 1601, a second electronic device 1604, or a server 1602, and the server 1602 may include an external DB 1603 or be electrically connected to the external DB 1603 and identity user information.

The first electronic device 1601 may store internal user data 1601a. For example, the internal user data 1601a may include information related to the user which is input through the first electronic device 1601 such as personal information and schedule information of the user of the first electronic device 1601.

The second electronic device 1604 may be a wearable device including at least one sensor 1604a.

The server 1602 may store user data 1602a. For example, the user data 1602a corresponds to information on an account and may include at least one account and identification information of the electronic device related to the corresponding account.

According to various embodiments of the present disclosure, the second electronic device 1604 may hand off the user input according to whether a task corresponding to the user input can be processed. For example, the user input may correspond to a task for identifying the personal information of the user based on the internal user data.

In operation 1610, the second electronic device 1604 may identify reception of the user input.

In operation 1620, the second electronic device 1604 may transmit a query for the made user input to the first electronic device 1601. For example, when the second electronic device 1604 cannot process the task corresponding to the user input, the second electronic device 1604 may identify at least one electronic device, which can process the task, and hand off a query that makes a request for processing the user input to the corresponding electronic device.

In operation 1621, the first electronic device 1601 may transmit the received query to the server 1602 and make a request for performing the task corresponding to the query. The query may include at least some of the internal user data 1601a and make a request for identifying a task related to the user input.

In operation 1630, the server 1602 may transmit the response to the query to the first electronic device 1601. For example, the response to the query may include information on the task which can be performed using the internal user data 1601a.

In operation 1631, the first electronic device 1601 may transmit the received response to the query to the second electronic device 1604 having received user input.

In operation 1640, the second electronic device 1604 may identify the response to the query as feedback of the user input.

According to various embodiments of the present disclosure, data on the feedback corresponds to a result of the performance of the task based on the internal user data 1601a and may be output through an input/output interface of the second electronic device 1704.

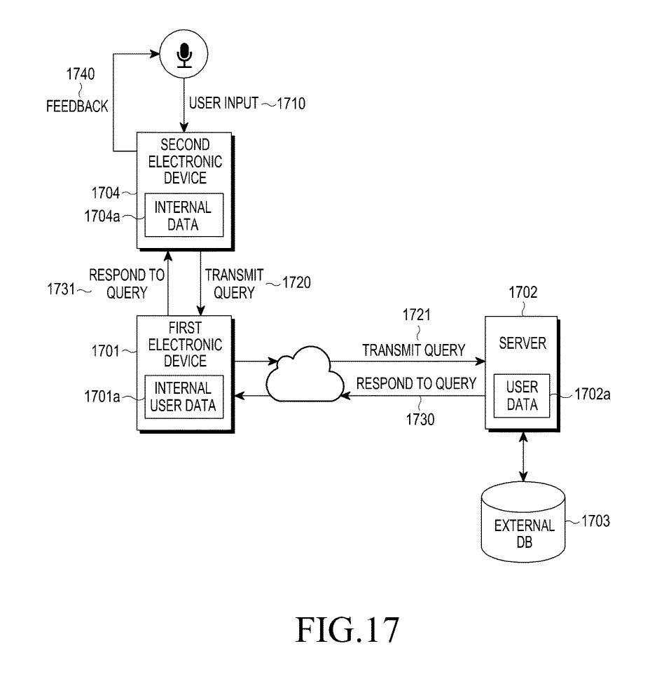

FIG. 17 is a diagram illustrating an example of a configuration of a system that processes a user input according to various example embodiments of the present disclosure.

Referring to FIG. 17, the system may include a first electronic device 1701, a second electronic device 1704, or a server 1702, and the server 1702 may include an external DB 1703 or be electrically connected to the external DB 1703 and identity user information.

The first electronic device 1701 may store internal user data 1701a. For example, the internal user data 1701a may include information related to the user which is input through the first electronic device 1701 such as personal information and schedule information of the user of the first electronic device 1701.

The second electronic device 1704 may include internal data 1704a. For example, the internal data 1704a may include data generated or detected through a configuration (for example, a module or a sensor) of the second electronic device 1704.

The server 1702 may store user data 1702a. For example, the user data 1702a corresponds to information on an account and may include at least one account and identification information of the electronic device related to the corresponding account.

According to various embodiments of the present disclosure, the second electronic device 1704 may hand off the user input according to whether a task corresponding to the user input can be processed. For example, the user input may correspond to a task for identifying the personal information of the user based on the internal user data.

In operation 1710, the second electronic device 1704 may identify that the user input is made.

In operation 1720, the second electronic device 1704 may transmit a query for the made user input to the first electronic device 1701. For example, when the second electronic device 1704 cannot process the task corresponding to the user input, the second electronic device 1704 may identify at least one electronic device, which can process the task, and hand off a query that makes a request for processing the user input to the corresponding electronic device.

In operation 1721, the first electronic device 1701 may transmit the received query to the server 1702 and make a request for performing the task corresponding to the query. The query may include at least some of the internal user data 1701a and make a request for identifying a task related to the user input.

In operation 1730, the server 1702 may transmit the response to the query to the first electronic device 1701. For example, the response to the query may include information on the task which can be performed using the internal user data 1701a.

In operation 1731, the first electronic device 1701 may transmit the received response to the query to the second electronic device 1704 having received user input.

In operation 1740, the second electronic device 1704 may identify the response to the query as feedback of the user input.

According to various embodiments of the present disclosure, data on the feedback corresponds to a result of the performance of the task based on the internal user data 1701a and may be output through an input/output interface of the second electronic device 1704.

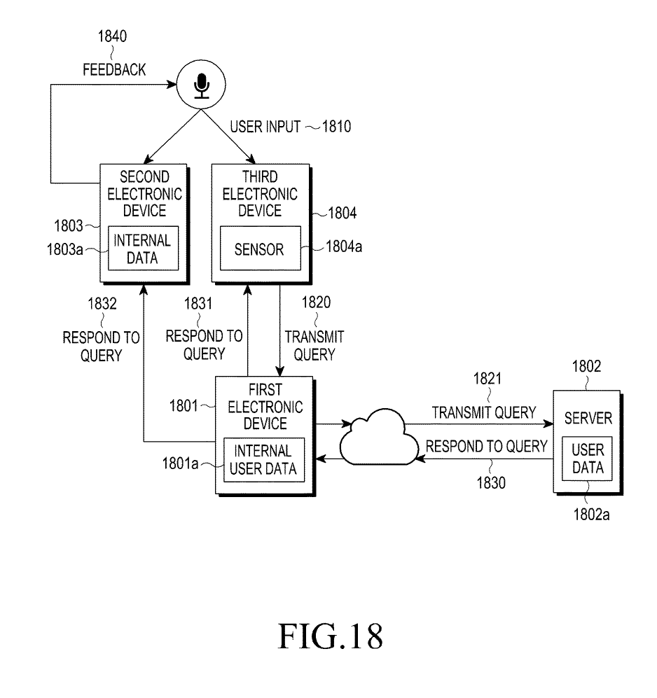

FIG. 18 is a diagram illustrating an example of a configuration of a system that processes a user input according to various example embodiments of the present disclosure.

Referring to FIG. 18, the system may include a first electronic device 1801, a second electronic device 1803, a third electronic device 1804, and a server 1802.

The first electronic device 1801 may store internal user data 1801a. For example, the internal user data 1801a may include information related to the user which is input through the first electronic device 1801 such as personal information and schedule information of the user of the first electronic device 1801.

The second electronic device 1803 may include internal data 1803a. For example, the internal data 1803a may include data generated or detected through a configuration (for example, a module or a sensor) of the second electronic device 1803.

The server 1802 may store user data 1802a. For example, the user data 1802a corresponds to information on an account and may include at least one account and identification information of the electronic device related to the corresponding account.

According to various embodiments of the present disclosure, the second electronic device 1803 or the third electronic device 1804 (including a sensor 1804a) may hand off a user input according to whether a task corresponding to the user input can be processed. For example, the user input may correspond to a task for identifying personal information of the user based on the internal user data.

In operation 1810, the second electronic device 1803 and the third electronic device 1804 may identify reception of the user input.

In operation 1820, the third electronic device 1804 may transmit a query for the received user input to the first electronic device 1801. For example, when the third electronic device 1804 cannot process the task corresponding to the user input, the third electronic device 1804 may identify at least one electronic device, which can process the task, and hand off a query that makes a request for processing the user input to the corresponding electronic device.

According to various embodiments of the present disclosure, the second electronic device 1803 or the third electronic device 1804 may determine the device to which the query for the user input is transmitted and which outputs a response. For example, the device to which the query is transmitted and which outputs the response may be determined based on at least one of a battery state of the second electronic device 1803 or the third electronic device 1804, a network state, a distance between the first electronic device 1801 and each of the devices, and a short-range communication state.

In operation 1821, the first electronic device 1801 may transmit the received query to the server 1802 and make a request for performing the task corresponding to the query. The query may include at least some of the internal user data 1801a and make a request for identifying a task related to the user input.

In operation 1830, the server 1802 may transmit the response to the query to the first electronic device 1801. For example, the response to the query may include information on the task which can be performed using the internal user data 1801a.

In operation 1831, the first electronic device 1801 may transmit the received response to the query to the third electronic device 1804 having received user input.

In operation 1832, the first electronic device 1801 may transmit the received response to the query to the second electronic device 1803 having received user input.

In operation 1840, the second electronic device 1803 may identify the response to the query as feedback of the user input.

According to various embodiments of the present disclosure, data on the feedback corresponds to a result of the performance of the task based on the internal user data 1801a and may be output through an input/output interface of the second electronic device 1803.

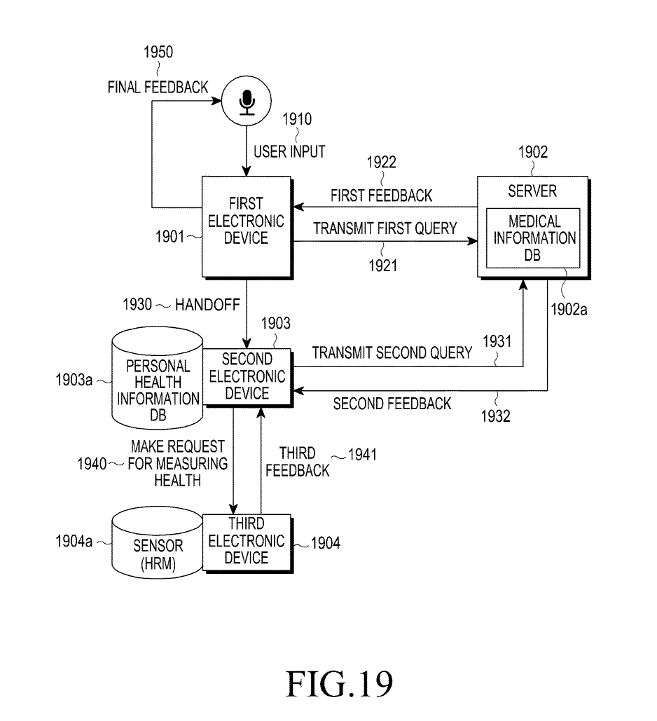

FIG. 19 is a diagram illustrating an example of a configuration of a system for processing a user input according to various embodiments of the present disclosure.

Referring to FIG. 19, the system may include a first electronic device 1901, a second electronic device 1903, a third electronic device 1904, or a server 1902.

The first electronic device 1901 may include an input/output interface for receiving a user input and outputting feedback thereof. For example, the user input may include data that inquires about whether personal health information can be identified or sensor data can be measured.

The second electronic device 1903 may include a personal health information DB 1903a. For example, the personal health information DB 1903a may include data related to the user of the second electronic device 1903 among data generated or detected through a configuration (for example, a module or a sensor) of the second electronic device 1903.

The third electronic device 1904 may include a sensor 1904a (for example, a Heart Rate Monitor (HRM)). For example, the sensor 1904a corresponds to a sensor for measuring a heart-rate and the third electronic device 1904 may identify a measured data value as a heart-rate value for a predetermined time.

The server 1902 may store a medical information DB 1902a. For example, the medical information DB 1902a corresponds to personal health information or medical information collected from an electronic device associated with at least one account and may include data indicating a state of each body part (heart, blood vessel, skin, and muscle).

In operation 1910, the first electronic device 1901 may identify reception of the user input.

In operation 1921, the first electronic device 1901 may transmit a first query that makes a request for identifying a task related to the user input to the server 1902. For example, the user input may include data that makes a request for measuring user's health information.

In operation 1922, the server 1902 may transmit first feedback of the first query to the first electronic device 1901. For example, the first feedback may indicate that the task corresponding to the first query cannot be processed by the first electronic device 1901.

In operation 1930, the first electronic device 1901 may hand off the first query. For example, as the first electronic device 1901 cannot process the first query, the first electronic device 1901 may hand off the first query to at least one electronic device which can process the first query.

In operation 1931, the second electronic device 1903 may transmit a second query to the server 1902 to make a request for identifying a task corresponding to the corresponding query. The second query may include the request for identifying the personal health information and the personal health information DB in the first query.

In operation 1932, the server 1902 may transmit second feedback of the second query to the second electronic device 1903. For example, the second feedback may include information on a processed result of the task related to the user input based on the personal health information DB 1903a.

According to various embodiments of the present disclosure, the second electronic device 1903 does not include the sensor, so the second electronic device 1903 may not be able to process the request for measuring the sensor data in the first query. In this case, the second electronic device 1903 may make a request for performing the operation, which cannot be processed, to the device (for example, the third electronic device 1904) including the sensor among devices connected through short-range communication in operation 1940.

In operation 1941, the third electronic device 1904 may transmit data measured through a sensor 1904a to the second electronic device 1903 as third feedback corresponding to the request for measuring the health information.

According to various embodiments of the present disclosure, the second electronic device 1903 may identify the received second feedback and third feedback and output the second feedback and the third feedback through an input/output interface of the second electronic device 1903.

According to various embodiments of the present disclosure, the second electronic device 1903 may transmit the received second feedback or third feedback to the first electronic device 1901. In operation 1950, the first electronic device 1901 may identify the feedbacks received from the second electronic device 1903 as final feedbacks and output the final feedbacks through an input/output interface.

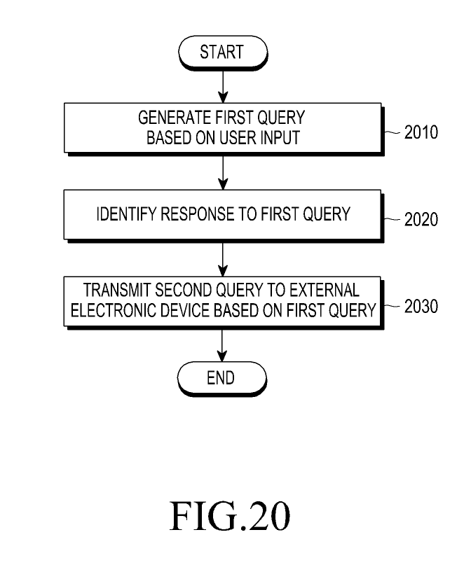

FIG. 20 is a flowchart illustrating an example of an operation of processing a user input by an electronic device according to various example embodiments of the present disclosure.

Referring to FIG. 20, in operation 2010, the electronic device may generate a first query based on a user input.

In operation 2020, the electronic device may identify a response to the first query. For example, when the first query cannot be processed by the electronic device, the response may include data that makes a request for processing the first query.

In operation 2030, the electronic device may generate a second query based on the first query and transmit the second query to an external electronic device. For example, the second query may include data that makes a request for information on an electronic device which can process the first query.

A method of processing a user input by an electronic device according to various embodiments of the present disclosure may further include: an operation of making a control to transmit the first query to a server through the external electronic device; and an operation of receiving the response from the server through the external electronic device.

The method of processing the user input by the electronic device according to various embodiments of the present disclosure may further include: an operation of making a control to not transmit the second query when the result meets a first precondition; and an operation of making a control to transmit the second query when the result meets a second precondition.

The method of processing the user input by the electronic device according to various embodiments of the present disclosure may further include: an operation of receiving the first response from another external electronic device through a first communication module among the at least one communication module; and an operation of transmitting the second query to the external electronic device through a second communication module among the at least one communication module.

The method of processing the user input by the electronic device according to various embodiments of the present disclosure may further include: an operation of selecting at least one external electronic device, which can process the second query, among the external electronic devices as the external electronic device at least based on the result.

The method of processing the user input by the electronic device according to various embodiments of the present disclosure may further include: an operation of receiving another response to the second query from the external electronic device; and an operation of providing the other response through an output device functionally connected to the processor.

The method of processing the user input by the electronic device according to various embodiments of the present disclosure may further include: an operation of receiving another response to a part of the second query from the external electronic device; and an operation of processing another part of the second query at least based on the other response.

The method of processing the user input by the electronic device according to various embodiments of the present disclosure may further include: an operation of identifying at least one operation related to a task; an operation of identifying at least one external electronic device which can perform the at least one operation, respectively; and an operation of transmitting information on the at least one operation which can be processed by the corresponding electronic devices to the at least one identified external electronic devices, respectively.

The method of processing the user input by the electronic device according to various embodiments of the present disclosure may further include: an operation of receiving an indication indicating whether the second query can be processed by the external electronic device from a server.

The method of processing the user input by the electronic device according to various embodiments of the present disclosure may further include: an operation of acquiring a voice input of a user corresponding to the electronic device as at least a part of the user input through a microphone of the electronic device; and an operation of identifying data corresponding to the acquired voice input as the query.

The method of processing the user input by the electronic device according to various embodiments of the present disclosure may further include: an operation of acquiring a text input as at least a part of the user input; and an operation of identifying data corresponding to the acquired text input as the query.

The method of processing the user input by the electronic device according to various embodiments of the present disclosure may further include: an operation of generating another query at least based on the first query; an operation of identifying a task to be performed in connection with the other query; an operation of making a control to not transmit the other query when the result meets a first precondition; and an operation of making a control to transmit the other query to the external electronic device through the communication module when the result meets a second precondition.

The method of processing the user input by the electronic device according to various embodiments of the present disclosure may further include: an operation of transmitting the other query to another external electronic device; an operation of receiving information on the task from the other external electronic device as a response to the other query; and an operation of transmitting at least a part of the query to the external electronic device at least based on the result.

The method of processing the user input by the electronic device according to various embodiments of the present disclosure may further include: an operation of identifying an external electronic device including a module for performing the operation related to the electronic payment among the at least one external electronic device; and an operation of selecting the identified external electronic device as an external electronic device which can perform the task.

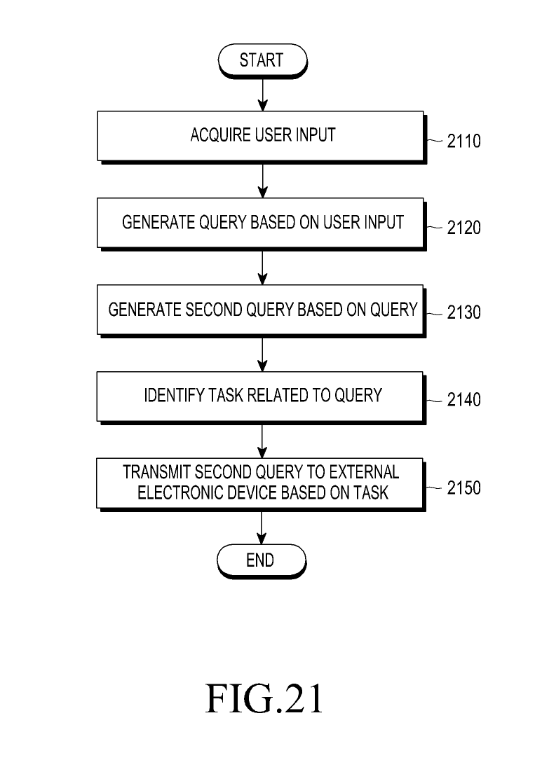

FIG. 21 is a flowchart illustrating an example of an operation of processing a user input by an electronic device according to various example embodiments of the present disclosure.

Referring to FIG. 21, in operation 2110, the electronic device may acquire a user input. For example, the electronic device may identify data input through a module or a sensor of the electronic device as the user input.

In operation 2120, the electronic device may generate a query based on the user input. For example, the electronic device may identify a domain related to the user input and generate the query including information on the domain.

In operation 2130, the electronic device may generate a second query based on the query. For example, when the domain cannot be identified, the electronic device may generate the second query including data that makes a request for identifying the domain.

In operation 2140, the electronic device may identify a task related to the query.

In operation 2150, the electronic device may transmit the second query including information on the identified task.

A method of processing a user input by an electronic device according to various embodiments of the present disclosure may include: an operation of generating a first query based on a user input; an operation of identifying a response to the first query; an operation of transmitting a second query generated at least based on the first query to an external electronic device, which can perform short-range communication, through at least one communication module, based on a result of the response; and an operation of setting the second query to be processed by the external electronic device.

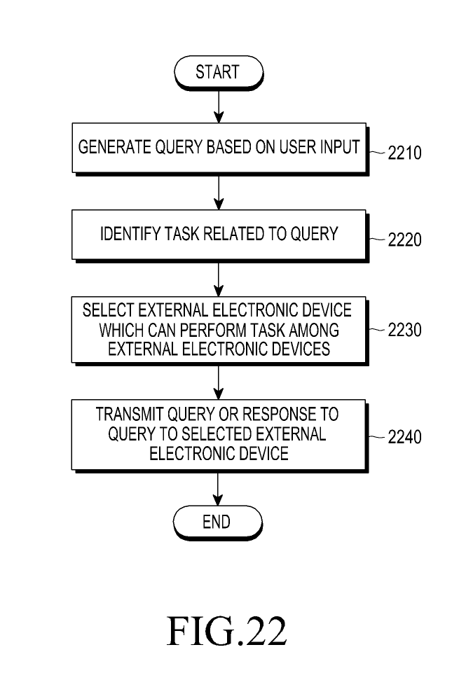

FIG. 22 is a flowchart illustrating an example of an operation for processing a user input by an electronic device according to various example embodiments of the present disclosure.

Referring to FIG. 22, in operation 2210, the electronic device may generate a query based on a user input.

In operation 2220, the electronic device may identify a task related to the query.

In operation 2230, the electronic device may select an external electronic device which can process the task among external electronic devices. For example, when the task related to the query cannot be processed by the electronic device, the electronic device may identify at least one external electronic device to make a request for performing the task.

In operation 2240, the electronic device may transmit the query or a response to the query to the selected external electronic device.

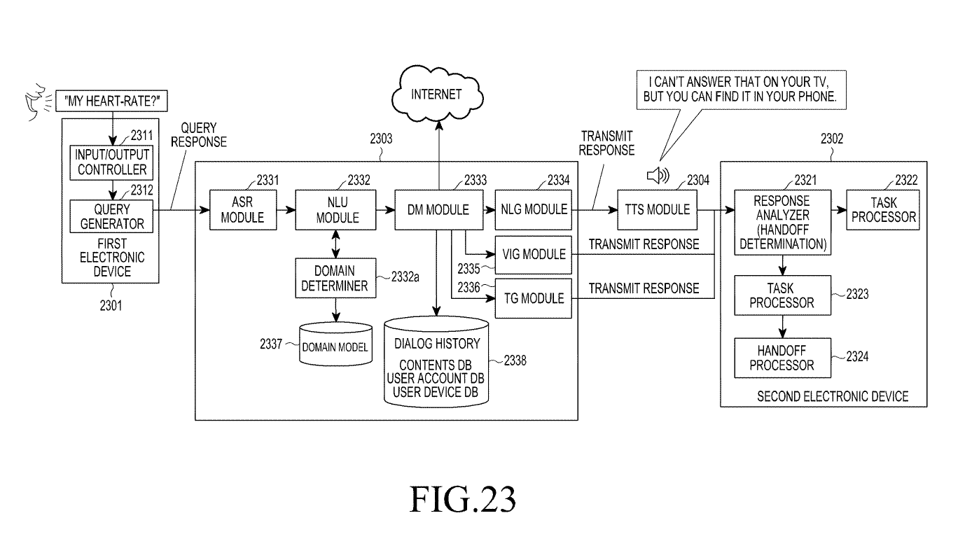

FIG. 23 is a diagram illustrating an example of a configuration of a system that processes a user input according to various embodiments of the present disclosure.

Referring to FIG. 23, the system may include a first electronic device 2301, a second electronic device 2302, a server 2303, or a TTS (text-to-speech synthesis) module 2304.

According to various embodiments of the present disclosure, although the first electronic device 2301, the second electronic device 2302, the server 2303, and the TTS module 2304 are illustrated as separated elements, at least one element may be omitted or changed. For example, a module of the server 2303 may be included in the first electronic device 2301, the first electronic device 2301 and the second electronic device 2302 may be configured to operate as one device, or the TTS module 2304 may be configured to be included in the first electronic device 2301 or the server 2303.

The first electronic device 2301 may include an input/output controller 2311 or a query generator 2312.

The input/output controller 2311 may identify reception of voice data (for example, “My heart-rate?”) that inquires about a heart-rate measurement value from the user and transmit the identified voice data to the query generator 2312.

The query generator 2312 may generate a query related to the received voice data and transmit the generated query to the server 2303. For example, the query may include data that makes a request for acquiring information on the user's heart-rate.

The server 2303 may include an Automatic Speech Recognition (ASR) module 2331, a Natural Language Understanding (NLU) module 2332, a domain determiner 2332a, a Dialog Management (DM) module 2333, a Natural Language Generation (NLG) module 2334, a Visual Information Generation (VIG) module 2335, or a Task Generation (TG) module 2336, and may store information related to a domain model 2337 or a dialog history 2338.

The ASR module 2331 may recognize voice data corresponding to the user input in the received query. For example, the query may include the user input, context information, or internal information of the first electronic device 2301.

The NLU module 2332 may extract a natural language from the voice data and convert the natural language into data which can be processed by the electronic device.

The domain determiner 2332a may receive the data converted from the natural language from the NLU module 2332 and determine a domain related to the data.

The DM module 2333 may transmit the query to an external electronic device (for example, the second electronic device 2302) and determine whether to process the query through the external electronic device.

The NLG module 2334 corresponds to a module for generating the natural language and may generate output data in the corresponding natural language. For example, the output data may include a response to the query, a processing result, or the received query.

According to various embodiments of the present disclosure, the NLG module 2334 may generate the response to the query in the natural language and transmit the generated natural language to the TTS module 2304.

The VIG module 2335 may generate the output data as image data. For example, the output data may include the processing result of the query. For example, the VIG module 2335 may generate the response to the query as the image data and transmit the generated image data to the second electronic device 2302.

The TG module 2336 may generate a task related to the received query as the response to the received query. For example, the task generated through the TG module 2336 may include information on at least one task related to the received query or information on operations for performing a particular task or the order of the operations.

According to various embodiments of the present disclosure the TG module 2336 may identify the task for the query and transmit the task to the second electronic device 2302 as the response to the query data.

The domain module 2337 corresponds to domain information related to a particular task and may include information on operations for performing the corresponding task and order of the operations.

The dialog history 2338 may include information related to voice data, for example, a content database related to particular voice data, a user account DB into which voice data is input, or a user device DB.

The second electronic device 2302 may include a response analyzer 2321, a task processor 2322, a query generator 2323, or a handoff processor 2324.

The response analyzer 2321 may analyze the response received from the server 2303 or the TTS module 2304. For example, the response analyzer 2321 may analyze whether a processing result of the particular query or task information related to the query is included in the received response.

The task processor 2322 may identify the task information included in the received response and make a control to perform the task. For example, the task processor 2322 may make a control to perform at least one operation based on orders of the operations for performing the particular task.

The query generator 2323 may generate another query based on the received query. For example, the query generator 2323 may generate a query that makes a request for processing the received query to an external electronic device based on an analysis result of the received query.

When it is determined that the query cannot be processed by the second electronic device 2302 based on the analysis result of the received query, the handoff processor 2324 may make a request for processing the received query to another external electronic device.

The TTS module 2304 may identify the response received from the server 2303 and output the response. For example, the response may include data (for example, “I can't answer that on your TV, but you can find it in your phone.”) indicating the processing result of the particular query.

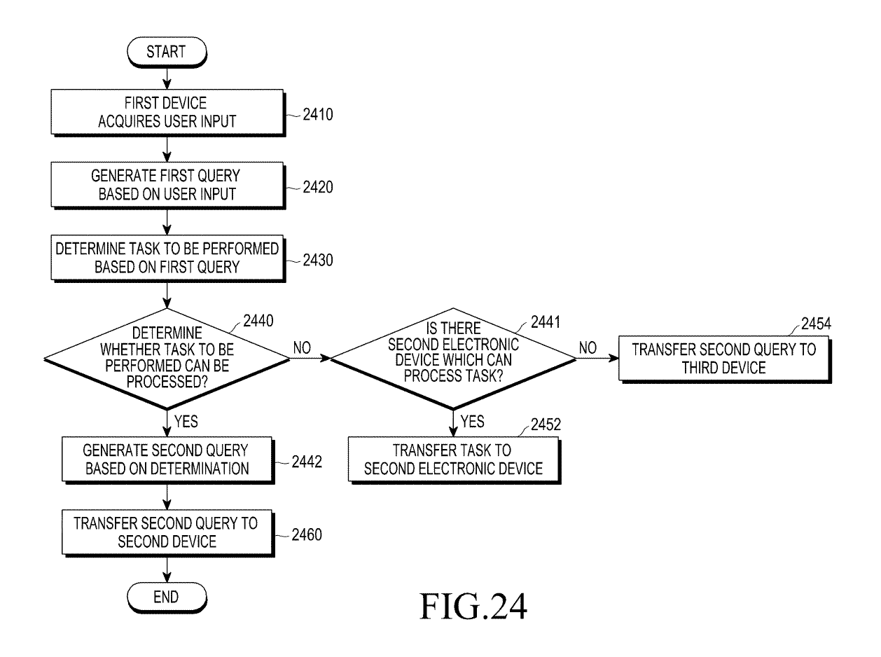

FIG. 24 is a flowchart illustrating an example of an operation for processing a user input by an electronic device according to various example embodiments of the present disclosure.

Referring to FIG. 24, in operation 2410, a first device (for example, the first electronic device 2301) may acquire a user input.

In operation 2420, the first device may generate a first query based on the user input. The first query may include data that identifies at least one task related to the user input and makes a request for processing the task.

In operation 2430, the first device may determine a task to be performed based on the first query.

In operation 2440, the first device may determine whether the task to be performed can be processed by the first device.

When it is determined that the task to be performed cannot be processed by the first device based on a result of the performance of operation 2440, the first device may determine whether there is a second device (for example, the second electronic device 2302) which can process the task in operation 2441.

When the second device cannot be identified based on a result of the performance of operation 2441, the first device may transmit a second query related to the first query to a third device in operation 2454. For example, the second query may include data that makes a request for identifying an electronic device which can process the first query.

When the second device is identified based on a result of the performance of operation 2441, the first device may transmit information on the task to be performed to the second device in operation 2452.

When it is determined that the task to be performed can be processed by the first device based on the result of the performance of operation 2440, the first device may generate the second query in operation 2442.

In operation 2460, the first device may transmit the second query to the second device.

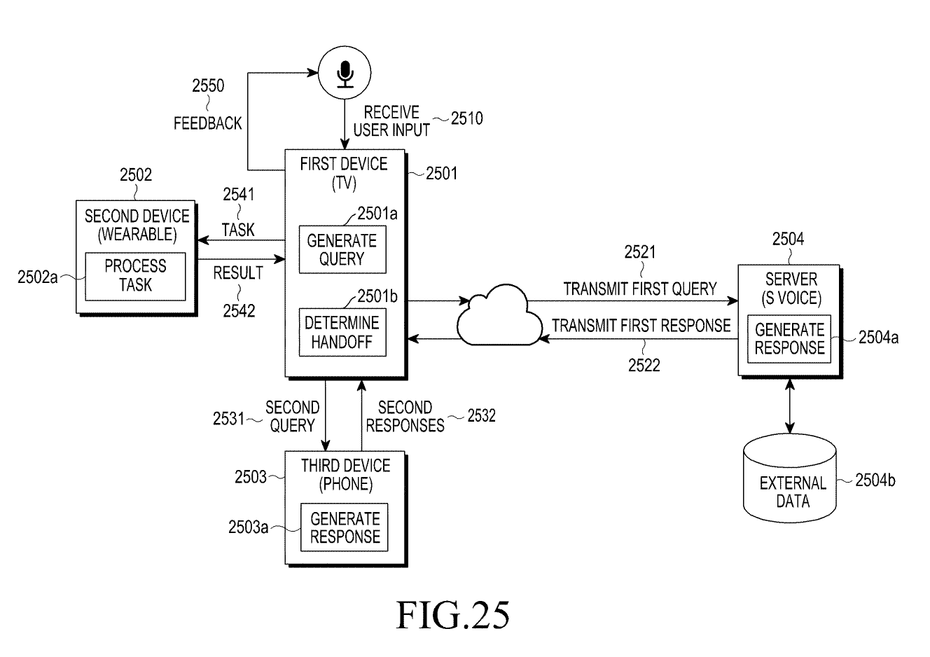

FIG. 25 is a diagram illustrating an example of a configuration of a system for processing a user input according to various example embodiments of the present disclosure.

Referring to FIG. 25, the system may include a first device 2501, a second device 2502, a third device 2503, or a server 2504.

The first device 2501 may be a TV, and may include a program or an application for generating a query as indicated by reference numeral 2501a or determining a handoff as indicated by reference numeral 2501b.

The second device 2502 may be a wearable device and may include a program or an application for performing task processing 2501a.

The third device 2503 may be a smart phone and may include a program or an application for generating a response as indicated by reference numeral 2503a.

The server 2504 may perform a voice recognition service (for example, S voice) and may include a program or an application for generating a response as indicated by reference numeral 2504a. For example, the server 2504 may store external data 2504b or may be connected to a device that stores the data.

In operation 2510, the first device 2501 may identify reception of a user input.

In operation 2521, the first device 2501 may generate a first query related to the user input and transmit the first query to the server 2504.

In operation 2522, the first device 2501 may receive a first response from the server 2504 as a response to the first query.

In operation 2531, the first device 2501 may transmit a second query to the third device 2503. For example, the second query may include data on whether the first query can be processed or data that makes a request for identifying a device which can process the first query.

In operation 2532, the first device 2501 may receive a second response from the third device 2503 as a response to the second query.

In operation 2541, the first device 2501 may transmit a task related to the second query to the second device 2502. For example, as information on the second device 2502 is included in the second response as the device which can process the second query, the first device 2501 may transmit the task to the second device 2502.

In operation 2542, the first device 2501 may receive a result of the performance of the task from the second device 2502.

In operation 2550, the first device 2501 may output feedback. For example, the feedback corresponds to the result of the performance of the task and may be output in the form of voice data or image data.

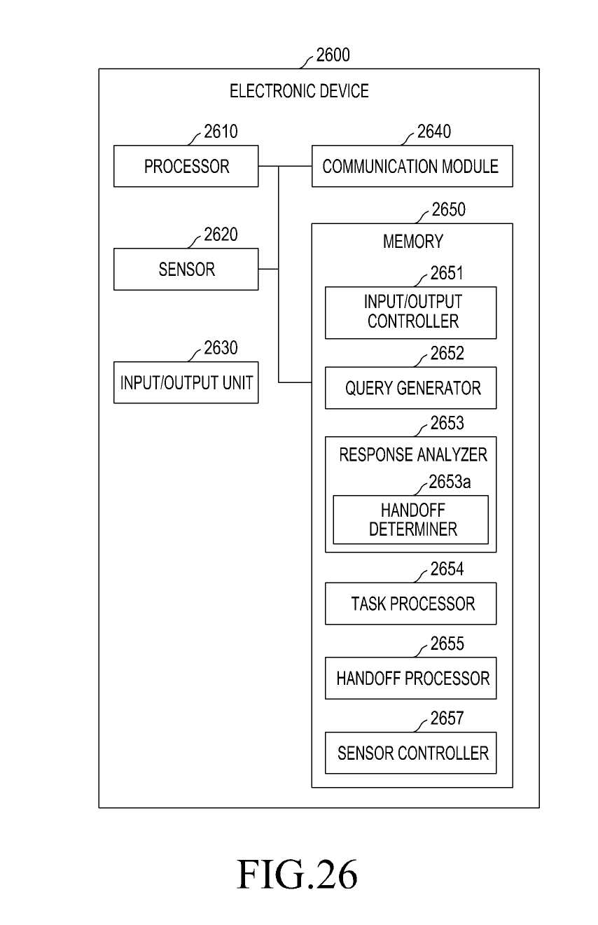

FIG. 26 is a block diagram illustrating an example of a configuration of an electronic device according to various example embodiments of the present disclosure.

Referring to FIG. 26, an electronic device 2600 may include a processor (e.g., including processing circuitry) 2610 (for example, the processor 220), a sensor 2620 (for example, the sensor module 250), an input/output unit (e.g., including input/output circuitry) 2630 (for example, the input/output module 230), a communication module (e.g., including communication circuitry) 2640 (for example, the communication module 210), or a memory 2650 (for example, the memory 240).

The processor 2610 may include various processing circuitry to determine whether a user input received through the input/output unit 2630 can be processed by the electronic device 2600.

The sensor 2620 may detect sensor data and, when the user input corresponds to a task related to measurement of the sensor data, transmit at least one piece of detected sensor data to the processor 2610.

The input/output unit 2630 may include various input/output circuitry to receive the user input and output a processing result of the query. For example, the input/output unit 2630 may convert the received user input into data which can be processed by the electronic device 2600 or identify data on the processing result and convert the data into data which can be identified by the user, and may output the converted data.

The communication module 2640 may include various communication circuitry and may be connected to an external device and transmit a query corresponding to the received user input or receive a processing result of the query.

The memory 2650 may store program information for controlling an input/output controller 2651, a query generator 2652, a response analyzer 2653, a task processor 2654, a handoff processor 2655, or a sensor controller 2657 or performing an operation corresponding to each element.

The memory 2650 may include information for identifying reception of the user input or information for outputting a result of the performance of the query as information of the input/output controller 2651.

The memory 2650 may include information for identifying a task related to the user input and generating a query related to the performance of the task as information of the query generator 2652.

The memory 2650 may include information for identifying a received response corresponding to the query transmitted to the external device and information for determining a result of the performance of a particular query as information of the response analyzer 2653.

The memory 2650 may include information for identifying a task related to a particular query and processing the corresponding task as information of the task processor 2654.

The memory 2650 may include information for determining whether the electronic device 2600 can process a task for a particular query and performing a handoff according to a result of the determination as information of the handoff processor 2655.

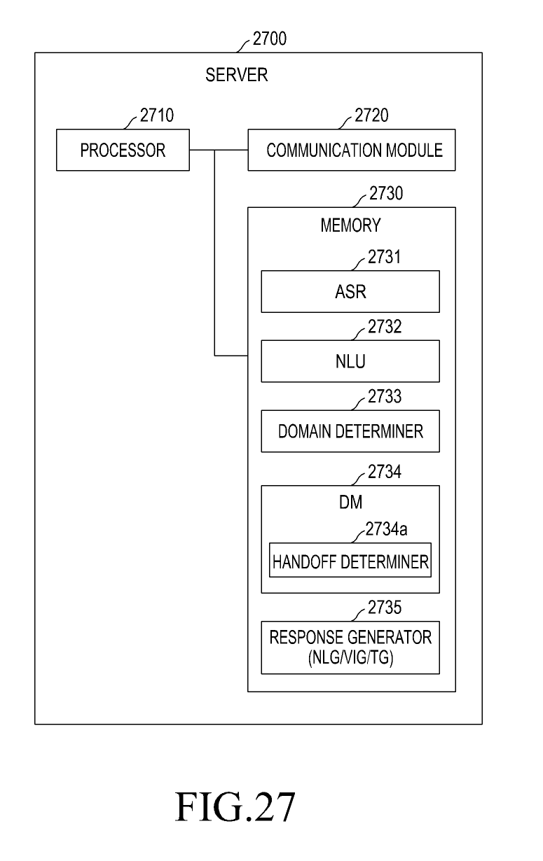

FIG. 27 is a block diagram illustrating an example of a configuration of a server according to various embodiments of the present disclosure.

Referring to FIG. 27, a server 2700 may include a processor (e.g., including processing circuitry) 2710, a communication module (e.g., including communication circuitry) 2720, and/or a memory 2730.

The processor 2710 may include various processing circuitry and receive a query related to a user input from at least one electronic device and determine whether the received query can be processed by a specific electronic device.

The communication module 2720 may include various communication circuitry and be connected to at least one electronic device to receive a query or transmit information on whether the received query can be processed to the corresponding electronic device.

The memory 2730 may store program information for controlling an ASR 2731 (for example, the ASR module 2331), an NLU 2732 (for example, the NLU module 2332), a domain determiner 2733 (for example, the domain determiner 2332a), a DM 2734 (for example, the DM module 2333), or a response generator 2735 or performing an operation corresponding to each module. For example, the DM 2734 may include information for performing an operation of a handoff determiner 2734a (for example, the response analyzer 2321).

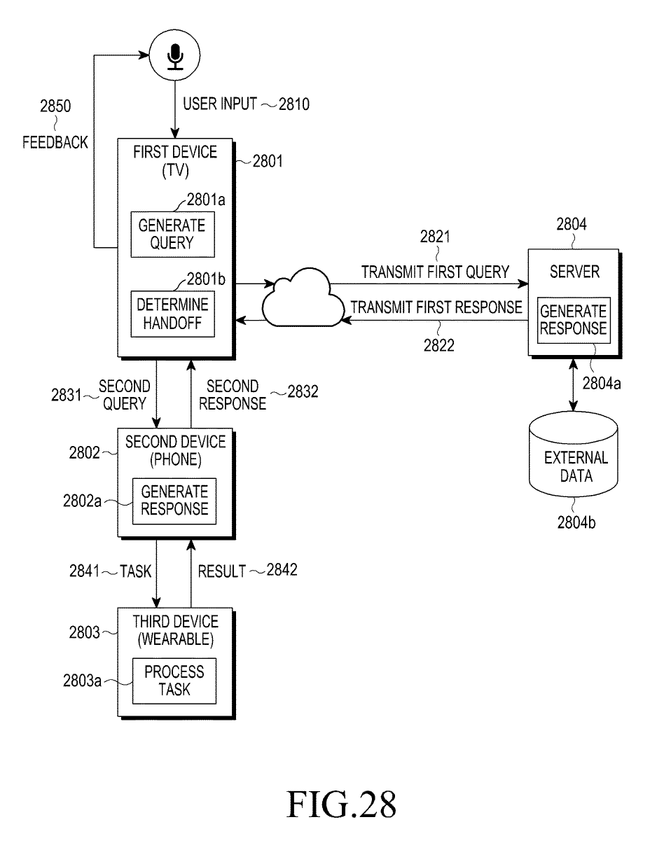

FIG. 28 is a diagram illustrating an example of a configuration of a system that processes a user input according to various example embodiments of the present disclosure.

Referring to FIG. 28, the system may include a first device 2801, a second device 2802, a third device 2803, or a server 2804.

The first device 2801 may include a module or a program for query generation 2801a or handoff determination 2801b.

The second device 2802 may include a module or a program for response generation 2802a.

The third device 2803 may include a module or a program for processing 2803a of a task related to the query.

The server 2804 may include a module or a program for response generation 2804a and may store an external database 2804b or may be connected to a device that stores the data.

In operation 2810, the first device 2801 may receive a user input.

In operation 2821, the first device 2801 may generate a first query corresponding to the received user input and transmit the generated first query to the server 2804.

In operation 2822, the first device 2801 may receive a first response generated in response to the first query from the server 2804.

In operation 2831, the first device 2801 may identify the first response and transmit a second query including data that makes a request for processing the first query to the second device 2802.

In operation 2832, the first device 2801 may receive a second response to the second query from the second device 2802. For example, the second response may include information on a device (for example, the third device 2803) which can process the second query or a result of the performance of the second query.

In operation 2841, the second device 2802 may transmit task information related to the second query to the third device 2803.

In operation 2842, the second device 2802 may receive a processing result of the task from the third device 2803.

In operation 2850, the first device 2801 may identify the second response and output the processing result of the task as feedback of the user input.

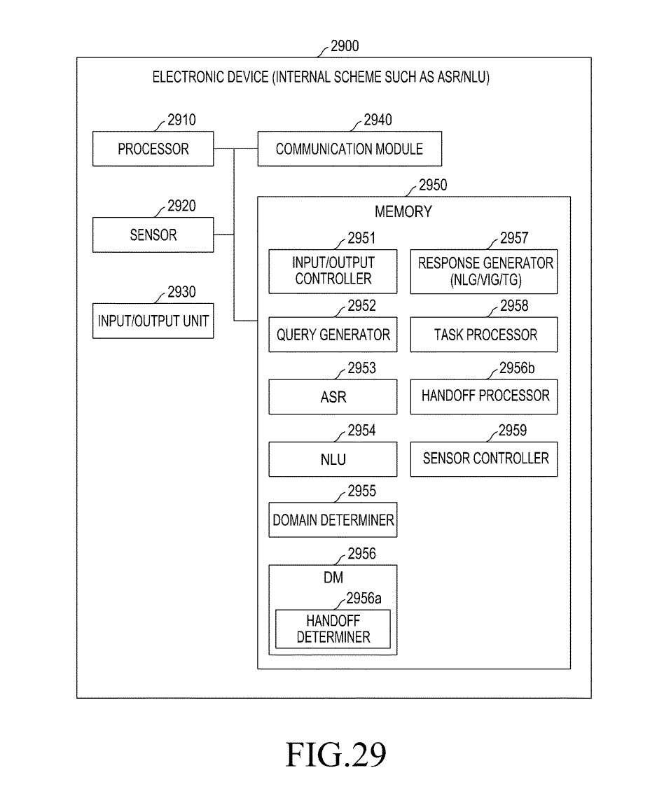

FIG. 29 is a block diagram illustrating an example of a configuration of an electronic device according to various example embodiments of the present disclosure.

Referring to FIG. 29, an electronic device 2900 may include a processor (e.g., including processing circuitry) 2910, a sensor 2920 (the sensor module 250), an input/output unit (e.g., including input/output circuitry) 2930 (for example, the input/output module 230), a communication module (e.g., including communication circuitry) 2940 (for example, the communication module 210), or a memory 2950 (for example, the memory 240).

The processor 2910 may include various processing circuitry and determine whether a user input received through the input/output unit 2930 can be processed by the electronic device 2900 or hand off the user input so that a query related to the input can be processed through at least one external electronic device.

The sensor 2920 may detect sensor data and, when the user input corresponds to a task related to measurement of the sensor data, transmit at least one piece of detected sensor data to the processor 2910.

The input/output unit 2930 may include various input/output circuitry and receive the user input and output a processing result of the query. For example, the input/output unit 2930 may include a result of the request for a handoff to at least one external device as a processing result of the query.

The communication module 2940 may include various communication circuitry and be connected to an external device and transmit a query corresponding to the received user input or receive a processing result of the query.

The memory 2950 may store program information for controlling an input/output controller 2951 (for example, the input/output controller 2311), a query generator 2952 (for example, the query generator 2323), an ASR 2953 (for example, the ASR module 2331), an NLU 2954 (for example, the NLU module 2332), a domain determiner 2955 (for example, the domain determiner 2332a), a DM 2956 (for example, the DM module 2333), a response generator 2957, a task processor 2958 (for example, the task processor 2322), a handoff processor 2956b (for example, the handoff processor 2324), or a sensor controller 2959 or performing an operation corresponding to each element.

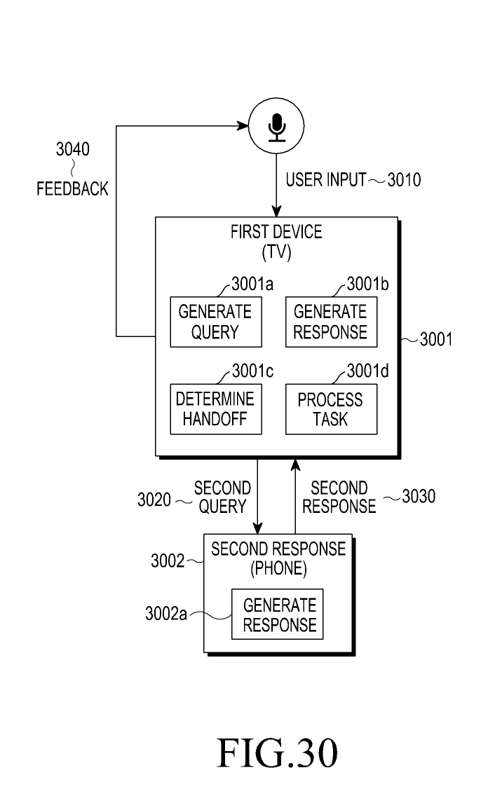

FIG. 30 is a diagram illustrating an example of a configuration of a system that processes a user input according to various example embodiments of the present disclosure.

Referring to FIG. 30, the system may include a first device 3001 (for example, a TV) or a second device 3002 (for example, a smart phone).

The first device 3001 may generate a query related to a user input as indicated by reference numeral 3001a, generate a response to the query as indicated by reference numeral 3001b, determine a handoff based on the response ad indicated by reference numeral 3001c, and control a module for processing a task related to the query as indicated by reference numeral 3001d or store program information for controlling an operation of each module.

The second device 3002 may control a module for generating a response to the received query as indicated by reference numeral 3002a or include program information for performing an operation of the module.

In operation 3010, the first device 3001 may identify reception of a user input.

In operation 3020, the first device 3001 may generate a second query corresponding to the user input and transmit the second query to the second device 3002. For example, as it is determined that the second query cannot be processed by the first device 3001 but can be processed by the second device 3002, the second query may include data that makes a request for a handoff to the second device 3002.

In operation 3030, the first device 3001 may receive a second response to the generated query from the second device 3002.

In operation 3040, the first device 3001 may output the second response to as feedback of the user input. For example, the feedback may include a processing result of the second query by the second device 3002.

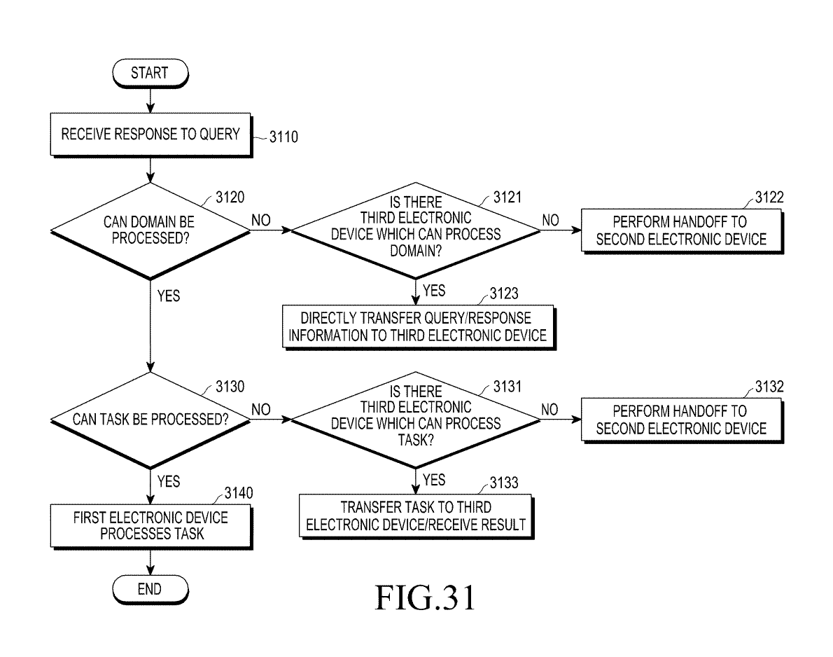

FIG. 31 is a flowchart illustrating an example of an operation in which a server processes a user input according to various example embodiments of the present disclosure.

Referring to FIG. 31, in operation 3110, the server may receive a response to a query from a first electronic device (for example, the first electronic device 2301).

In operation 3120, the server may identify the received response and determine whether the query corresponds to a domain which can be processed by the first electronic device.

When the first electronic device cannot process the domain based on a result of the performance of operation 3120, the server may determine whether there is a third electronic device, which can process the domain, in operation 3121.

When there is no third electronic device which can process the domain based on a result of the performance of operation 3121, the server may perform a handoff that makes a request for processing the domain to a second electronic device in operation 3122.

When there is the third electronic device which can process the domain based on the result of the performance of operation 3121, the server may directly transfer information related to the query or the response to the query to the third electronic device in operation 3123. For example, the server may make a control to transmit the query or the response to the third electronic device without passing through another electronic device.

When the first electronic device can process the domain based on the result of the performance of operation 3120, the server may determine whether the first electronic device can process a task related to the domain in operation 3130.

When the first electronic device cannot process the task related to the domain based on a result of the performance of operation 3130, the server may determine whether there is a third electronic device which can process the task in operation 3131.

When there is no third electronic device based on a result of the performance of operation 3131, the server may perform a handoff that makes a request for processing the task to the second electronic device in operation 3132.

When there is the third electronic device based on the result of the performance of operation 3131, the server may transfer the task to the third electronic device and receive a result of the performance of the task in operation 3133.

When the first electronic device can process the task related to the domain based on the result of the performance of operation 3130, the server may transfer data that makes a request for processing the task to the first electronic device in operation 3140.

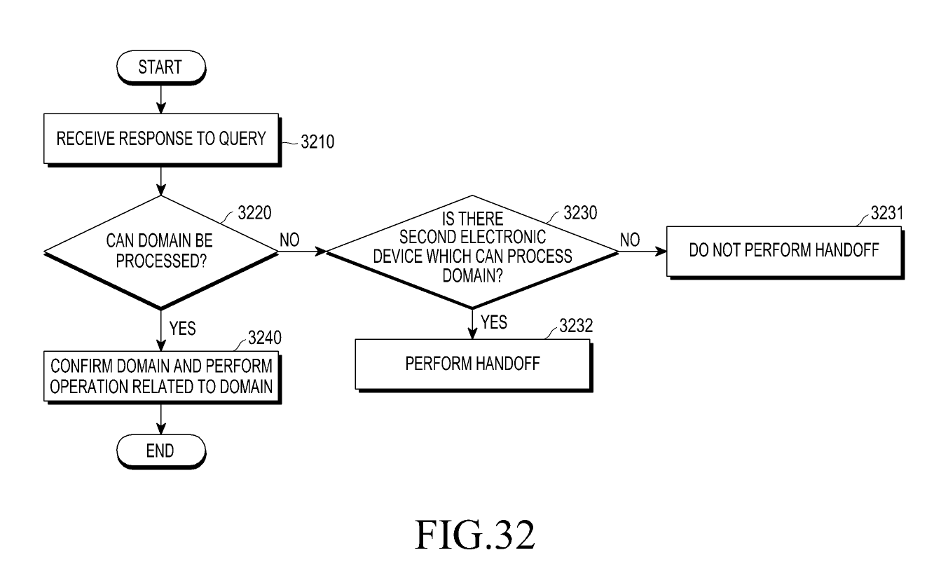

FIG. 32 is a flowchart illustrating an example of an operation for processing a user input by an electronic device according to various example embodiments of the present disclosure.

Referring to FIG. 32, in operation 3210, a first electronic device (for example, the first electronic device 2301) may receive a response according to transmission of a query related to a user input to an external electronic device.

In operation 3220, the first electronic device may determine whether a domain related to the query corresponds to a domain which can be processed by the first electronic device.

When the domain related to the query cannot be identified or processed based on a result of the performance of operation 3220, the first electronic device may identify whether there is a second electronic device which can process the domain among external electronic devices in operation 3230.

When there is no second electronic device based on a result of the performance of operation 3230, the first electronic device may make a control to not perform a handoff in operation 3231.

When it is determined that the second electronic device exists based on the result of the performance of operation 3230, the first electronic device may perform a handoff that makes a request for processing the query to a second electronic device in operation 3232.

When the domain related to the query can be processed based on the result of the performance of operation 3220, the first electronic device may confirm the domain and perform an operation related to the domain in operation 3240. For example, the first electronic device may sequentially perform at least one operation related to the domain according an order set in information on the domain.

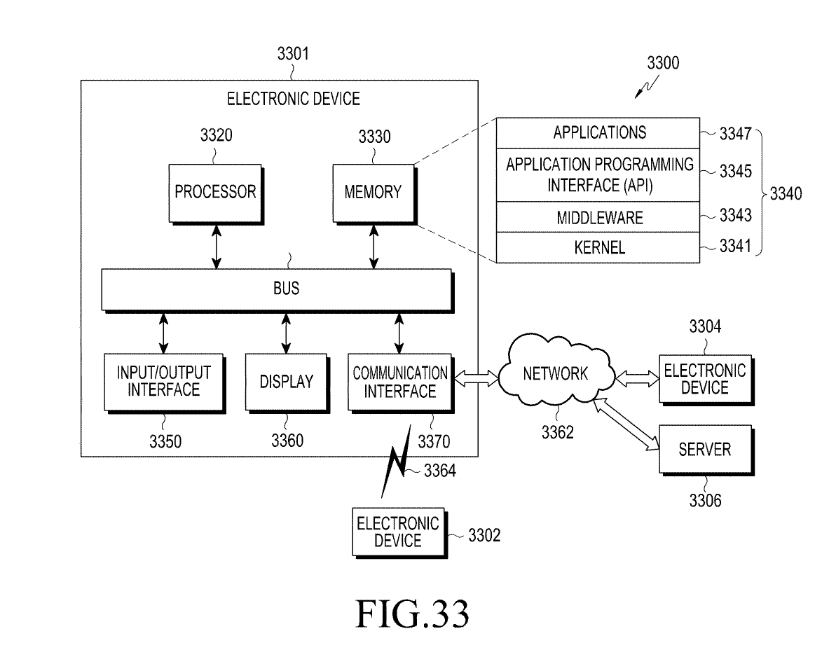

FIG. 33 is a block diagram illustrating an example of a network environment, according to various example embodiments of the present disclosure.

Referring to FIG. 33, a network environment 3300 may include an electronic device 3301, and at least one electronic device (for example, a first neighboring device 3302 or a second neighboring device 3304) or a server 3306, and the elements may be connected through a network 3362 or connected to the electronic device 3301 through a communication module 3370 of the electronic device 3301.

The electronic device 3301 may include a bus 3310, a processor (e.g., including processing circuitry) 3320, a memory 3330, an input/output interface (e.g., including input/output circuitry) 3350, a display 3360, and a communication module (e.g., including communication circuitry) 3370. In some embodiments, the electronic device 3301 may omit at least one of the elements, or may further include other elements.

The bus 3310 may include, for example, a circuit which interconnects the elements 3310 to 3370 and delivers communication (for example, a control message and/or data) between the elements 3310 to 3370.

The processor 3320 may include various processing circuitry, such as, for example, and without limitation, one or more of a Central Processing Unit (CPU), an Application Processor (AP), and a Communication Processor (CP). The processor 3320, for example, may carry out operations or data processing relating to the control and/or communication of at least one other element of the electronic device 3301.

The memory 3330 may include a volatile and/or non-volatile memory. The memory 3330 may store, for example, instructions or data relevant to at least one other element of the electronic device 3301. According to an embodiment, the memory 3330 may store software and/or a program 3340. The program 3340 may include, for example, a kernel 3341, middleware 3343, an Application Programming Interface (API) 3345, and/or application programs (or “applications”) 3347. At least some of the kernel 3341, the middleware 3343, and the API 3345 may be referred to as an Operating System (OS).

For example, the kernel 3341 may control or manage the system resources (for example, the bus 3310, the processor 3320, the memory 3330, and the like) that are used to execute operations or functions implemented in the other programs (for example, the middleware 3343, the API 3345, and the application programs 3347). Furthermore, the kernel 3341 may provide an interface through which the middleware 3343, the API 3345, or the application programs 3347 may access the individual elements of the electronic device 3301 to control or manage the system resources.

The middleware 3343 may function as, for example, an intermediary for allowing the API 3345 or the application programs 3347 to communicate with the kernel 3341 to exchange data.

Furthermore, the middleware 3343 may process one or more task requests, which are received from the application programs 3347, according to priorities thereof. For example, the middleware 3343 may assign priorities for using the system resources (for example, the bus 3310, the processor 3320, the memory 3330, and the like) of the electronic device 3301 to one or more of the application programs 3347. For example, the middleware 3343 may perform scheduling or loading balancing on the one or more task requests by processing the one or more task requests according to the priorities assigned to the one or more application programs.

The API 3345, which is an interface through which the applications 3347 control functions provided from the kernel 3341 or the middleware 3343, may include, for example, at least one interface or function (for example, an instruction) for file control, window control, image processing, text control, and the like.

The input/output interface 3350 may include various input/output circuitry that function as, for example, an interface that can forward instructions or data, which are input from a user or an external device, to the other element(s) of the electronic device 3301. Furthermore, the input/output interface 3350 may output instructions or data, which are received from the other element(s) of the electronic device 3301, to the user or the external device.

Examples of the display 3360 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. The display 3360 may display, for example, various types of contents (for example, text, images, videos, icons, symbols, and the like) for a user. The display 3360 may include a touch screen and may receive, for example, a touch, gesture, proximity, or hovering input using an electronic pen or the user's body part.

The communication module 3370 may include various communication circuitry and configure communication, for example, between the electronic device 3301 and an external device (for example, a first external electronic device 3302, a second external electronic device 3304, or a server 3306). For example, the communication module 3370 may be connected to a network 3362 through wireless or wired communication to communicate with the external device (for example, the second external electronic device 3304 or the server 3306).

The wireless communication may use, for example, at least one of Long Term Evolution (LTE), LTE-Advance (LTE-A), Code Division Multiple Access (CDMA), Wideband CDMA (WCDMA), Universal Mobile Telecommunications System (UNITS), WiBro (Wireless Broadband), Global System for Mobile Communications (GSM), and the like, as a cellular communication protocol. In addition, the wireless communication may include, for example, short range communication 3364. The short range communication 3364 may include, for example, at least one of Wi-Fi, Bluetooth, Near Field Communication (NFC), Global Navigation Satellite System (GNSS), and the like. The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, “GPS” may be interchangeably used with “GNSS”. The wired communication may include, for example, at least one of a Universal Serial Bus (USB), a High Definition Multimedia Interface (HDMI), Recommended Standard 232 (RS-232), a Plain Old Telephone Service (POTS), and the like. The network 3362 may include at least one of a communication network such as a computer network (for example, a LAN or a WAN), the Internet, and a telephone network.

Each of the first and second external electronic devices 3302 and 3304 may be of the same or a different type from the electronic device 3301. According to an embodiment, the server 3306 may include a group of one or more servers. According to various embodiments, all or some of the operations executed in the electronic device 3301 may be executed in another electronic device or a plurality of electronic devices (for example, the electronic devices 3302 and 3304, or the server 3306). According to an embodiment, when the electronic device 3301 has to perform some functions or services automatically or in response to a request, the electronic device 3301 may request another device (for example, the electronic device 3302 or 3304 or the server 3306) to perform at least some functions relating thereto instead of, or in addition to, performing the functions or services by itself. Another electronic device (for example, the electronic device 3302 or 3304, or the server 3306) may execute the requested functions or the additional functions, and may deliver a result of the execution to the electronic device 3301. The electronic device 3301 may provide the received result as it is, or may additionally process the received result to provide the requested functions or services. To this end, for example, cloud computing, distributed computing, or client-server computing technology may be used.

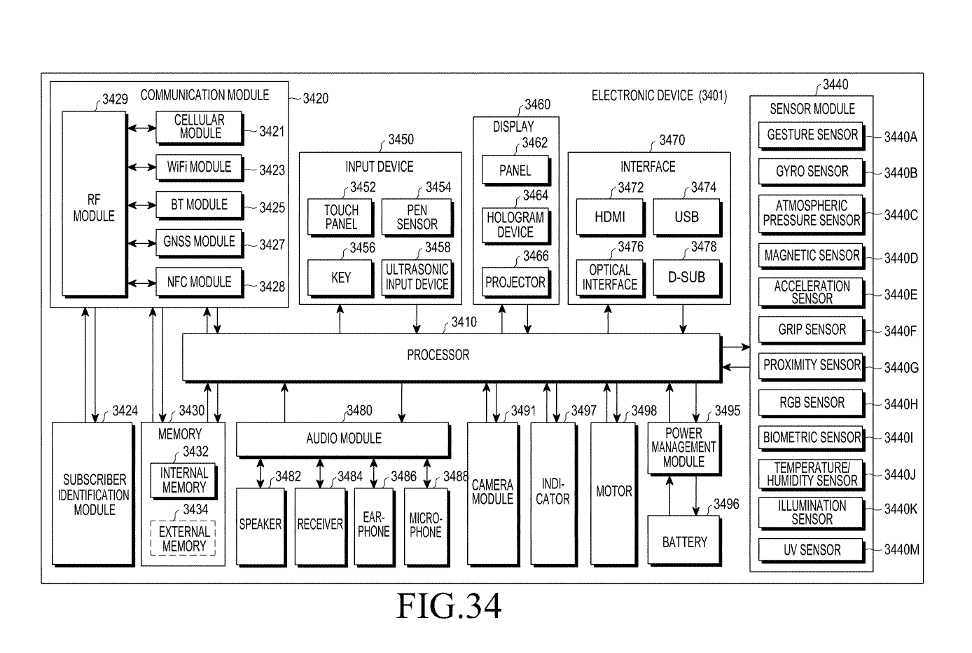

FIG. 34 is a block diagram illustrating an example configuration of an electronic device according to various example embodiments of the present disclosure.

Referring to FIG. 34, an electronic device 3401 may include, for example, the entirety or a part of the electronic device 3301 illustrated in FIG. 33. The electronic device 3401 may include at least one Application Processor (AP) (e.g., including processing circuitry) 3410, a communication module (e.g., including communication circuitry) 3420, a Subscriber Identification Module (SIM) card 3424, a memory 3430, a sensor module 3440, an input device (e.g., including input circuitry) 3450, a display 3460, an interface (e.g., including interface circuitry) 3470, an audio module 3480, a camera module 3491, a power management module 3495, a battery 3496, an indicator 3497, and a motor 3498.

The processor 3410 may drive, for example, an operating system or application programs to control a plurality of hardware or software elements connected thereto and may perform various types of data processing and operations. The processor 3410 may include various processing circuitry and may be realized, for example, as a System on Chip (SoC). According to an embodiment, the processor 3410 may further include a Graphic Processing Unit (GPU) and/or an image signal processor. The processor 3410 may also include at least some (for example, a cellular module 3421) of the elements illustrated in FIG. 34. The processor 3410 may load, in a volatile memory, instructions or data received from at least one of the other elements (for example, a non-volatile memory) to process the loaded instructions or data, and may store various types of data in the non-volatile memory.

The communication module 3420 may have a configuration equal or similar to that of the communication module 3370 of FIG. 33. The communication module 3420 may include various communication circuitry, such as, for example, and without limitation, a cellular module 3421, a Wi-Fi module 3423, a BT module 3425, a GNSS module 3427 (for example, a GPS module, a Glonass module, a Beidou module, or a Galileo module), an NFC module 3428, and a Radio Frequency (RF) module 3429.

The cellular module 3421 may provide, for example, a voice call, a video call, a text message service, an Internet service, and the like through a communication network. According to an embodiment of the present disclosure, the cellular module 3421 may identify or authenticate an electronic device 3401 in the communication network by using the subscriber identification module (for example, a Subscriber Identity Module (SIM) card) 3422. According to an embodiment, the cellular module 3421 may perform at least some of the functions that the AP 3410 may provide. According to an embodiment, the cellular module 3421 may include a Communication Processor (CP).

The Wi-Fi module 3423, the BT module 3425, the GNSS module 3427, or the NFC module 3428 may include, for example, a processor for processing data that is transmitted and received through the corresponding module. In some embodiments, at least some (two or more) of the cellular module 3421, the Wi-Fi module 3423, the Bluetooth module 3425, the GNSS module 3427, and the NFC module 3428 may be included in a single Integrated Chip (IC) or IC package.

The RF module 3429, for example, may transmit/receive a communication signal (for example, an RF signal). The RF module 3429 may include, for example, a transceiver, a Power Amplifier Module (PAM), a frequency filter, a Low Noise Amplifier (LNA), an antenna, and the like. According to another embodiment, at least one of the cellular module 3421, the Wi-Fi module 3423, the Bluetooth module 3425, the GNSS module 3427, and the NFC module 3428 may transmit/receive an RF signal through a separate RF module.

The subscriber identification module 3424 may include, for example, a card that includes a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 3430 (for example, the memory 3330) may include, for example, an internal memory 3432 and/or an external memory 3434. The internal memory 3432 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 3434 may further include a flash drive, for example, a Compact Flash (CF), a Secure Digital (SD), a Micro-Secure Digital (Micro-SD), a Mini-Secure Digital (Mini-SD), an extreme Digital (xD), a Multi-Media Card (MMC), a memory stick, or the like. The external memory 3434 may be functionally and/or physically connected to the electronic device 3401 through various interfaces.

The sensor module 3440 may, for example, measure a physical quantity or detect the operating state of the electronic device 3401 and may convert the measured or detected information into an electrical signal. The sensor module 3440 may include, for example, at least one of a gesture sensor 3440A, a gyro sensor 3440B, an atmospheric pressure sensor 3340C, a magnetic sensor 3340D, an acceleration sensor 3340E, a grip sensor 3340F, a proximity sensor 3340G a color sensor 3340H (for example, a Red, Green, and Blue (RGB) sensor), a biometric sensor 3340I, a temperature/humidity sensor 3440J, an illumination sensor 3440K, and a ultraviolet (UV) sensor 3340M. Additionally or alternatively, the sensor module 3340 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 3440 may further include a control circuit for controlling one or more sensors included therein. In some embodiments, the electronic device 3401 may further include a processor, which is configured to control the sensor module 3440, as a part of the processor 3410 or separately from the processor 3410 in order to control the sensor module 3440 while the processor 3410 is in a sleep state.

The input device 3450 may include various input circuitry, such as, for example, and without limitation, a touch panel 3452, a (digital) pen sensor 3454, a key 3456, or an ultrasonic input unit 3458. The touch panel 3452 may use, for example, at least one of a capacitive type, a resistive type, an infrared type, and an ultrasonic type. Furthermore, the touch panel 3452 may further include a control circuit. The touch panel 3452 may further include a tactile layer to provide a tactile reaction to a user.

The (digital) pen sensor 3454 may include, for example, a recognition sheet that is a part of, or separate from, the touch panel. The key 3456 may include, for example, a physical button, an optical key, or a keypad. The ultrasonic input device 3458 may detect ultrasonic waves, which are generated by an input tool, through a microphone (for example, a microphone 3488) to identify data corresponding to the detected ultrasonic waves.

The display 3460 (for example, the display 3360) may include a panel 3462, a hologram device 3464, or a projector 3466. The panel 3462 may have a configuration that is the same as, or similar to, that of the display 3360 illustrated in FIG. 33. The panel 3462 may be implemented to be, for example, flexible, transparent, or wearable. The panel 3462, together with the touch panel 3452, may be implemented as one module. The hologram device 3464 may show a three dimensional image in the air by using interference of light. The projector 3466 may display an image by projecting light onto a screen. The screen may be located, for example, in the interior of, or on the exterior of, the electronic device 3401. According to an embodiment, the display 3460 may further include a control circuit for controlling the panel 3462, the hologram device 3464, or the projector 3466.

The interface 3470 may include various interface circuitry, such as, for example, and without limitation, a High-Definition Multimedia Interface (HDMI) 3472, a Universal Serial Bus (USB) 3474, an optical interface 3476, or a D-subminiature (D-sub) 3478. The interface 3470 may be included in, for example, the communication interface 3370 illustrated in FIG. 33. Additionally or alternatively, the interface 3470 may include, for example, a Mobile High-definition Link (MHL) interface, a Secure Digital (SD) card/Multi-Media Card (MMC) interface, or an Infrared Data Association (IrDA) standard interface.

The audio module 3480 may convert, for example, a sound into an electrical signal, and vice versa. At least some elements of the audio module 3480 may be included, for example, in the input/output interface 3345 illustrated in FIG. 33. The audio module 3480 may process sound information that is input or output through, for example, a speaker 3482, a receiver 3484, earphones 3486, the microphone 3488, and the like.

The camera module 3491 is, for example, a device which may photograph a still image and a video. According to an embodiment of the present disclosure, the camera module 3491 may include one or more image sensors (for example, a front sensor or a back sensor), a lens, an Image Signal Processor (ISP) or a flash (for example, LED or xenon lamp).

The power management module 3495 may manage, for example, the power of the electronic device 3401. According to an embodiment, the power management module 3495 may include a Power Management Integrated Circuit (PMIC), a charger Integrated Circuit (IC), or a battery or fuel gauge. The PMIC may use a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 3496 and a voltage, current, or temperature while charging. The battery 3496 may include, for example, a rechargeable battery and/or a solar battery.

The indicator 3497 may indicate a particular state (for example, a booting state, a message state, a charging state, and the like) of the electronic device 3401 or a part (for example, the processor 3410) thereof. The motor 3498 may convert an electrical signal into a mechanical vibration and may generate a vibration, a haptic effect, and the like. Although not illustrated, the electronic device 3401 may include a processing unit (for example, a GPU) for supporting mobile TV. The processing unit for supporting the mobile TV may process media data according to a standard, such as Digital Multimedia Broadcasting (DMB), Digital Video Broadcasting (DVB), MediaFlo™, and the like.

Each of the above-described component elements of hardware according to the present disclosure may be configured with one or more components, and the names of the corresponding component elements may vary based on the type of electronic device.

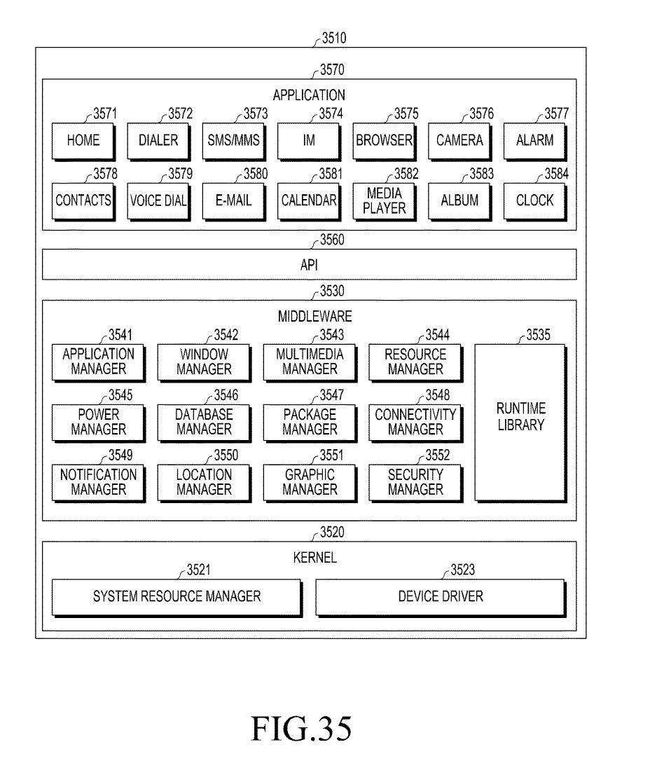

In various embodiments of the present disclosure, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling. FIG. 35 is a block diagram illustrating an example of a configuration of a program module according to various embodiments of the present disclosure.

Referring to FIG. 35, the program module 3510 (for example, the program 3340) may include an Operating System (OS) for controlling resources related to the electronic device (for example, the electronic device 3301) and/or various applications (for example, the application programs 3347) executed in the operating system.

The operating system may be, for example, Android, iOS, Windows, Symbian, Tizen, Bada, and the like

The program module 3510 may include a kernel 3520, middleware 3530, an Application Programming Interface (API) 3560, and/or applications 3570. At least a part of the program module 3510 may be preloaded on the electronic device, or may be downloaded from an external electronic device (for example, the electronic device 3302 or 3304 or the server 3306).

The kernel 3520 (for example, the kernel 3341) may include, for example, a system resource manager 3521 and/or a device driver 3523. The system resource manager 3521 may control, allocate, or retrieve system resources. According to an embodiment, the system resource manager 3521 may include a process management unit, a memory management unit, or a file system management unit. The device driver 3523 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 3530 may provide a function required by the applications 3570 in common or provide various functions to the applications 3570 through the API 3560 so that the applications 3570 can efficiently use limited system resources within the electronic device. According to an embodiment, the middleware 3530 (for example, the middleware 3343) may include, for example, at least one of a runtime library 3535, an application manager 3541, a window manager 3542, a multimedia manager 3543, a resource manager 3544, a power manager 3545, a database manager 3546, a package manager 3547, a connectivity manager 3548, a notification manager 3549, a location manager 3550, a graphic manager 3551, and a security manager 3552.

The runtime library 3535 may include, for example, a library module that a compiler uses in order to add a new function through a programming language while the applications 3570 are being executed. The runtime library 3535 may perform input/output management, memory management, the functionality for an arithmetic function, and the like.

The application manager 3541 may manage, for example, the life cycle of at least one of the applications 3570. The window manager 3542 may manage Graphical User Interface (GUI) resources used on a screen. The multimedia manager 3543 may determine formats required to reproduce various media files and may encode or decode a media file using a coder/decoder (codec) appropriate for the corresponding format. The resource manager 3544 may manage resources, such as the source code, the memory, the storage space, and the like of at least one of the applications 3570.

The power manager 3545 may operate together with, for example, a Basic Input/Output System (BIOS) to manage a battery or power and provide power information required for the operation of the electronic device. The database manager 3546 may generate, search for, and/or change a database to be used by at least one of the applications 3570. The package manager 3547 may manage the installation or update of an application that is distributed in the form of a package file.

The connectivity manager 3548 may manage a wireless connection, such as Wi-Fi, Bluetooth, and the like. The notification manager 3549 may display or notify of an event, such as an arrival message, an appointment, a proximity notification, and the like in such a manner as not to disturb a user. The location manager 3550 may manage the location information of the electronic device. The graphic manager 3551 may manage a graphic effect to be provided to a user and a user interface relating to the graphic effect. The security manager 3552 may provide various security functions required for system security, user authentication, and the like. According to an embodiment, when the electronic device (for example, the electronic device 3301) has a telephone call function, the middleware 3530 may further include a telephony manager that manages a voice or video call function of the electronic device.

The middleware 3530 may include a middleware module that forms a combination of various functions of the above-described elements. The middleware 3530 may provide specialized modules according to the types of operating systems in order to provide differentiated functions. Furthermore, the middleware 3530 may dynamically remove some of the existing elements, or may add new elements.

The API 3560 (for example, the API 3345) is, for example, a set of API programming functions, and may be provided with different configurations according to operating systems. For example, in the case of Android or iOS, one API set may be provided for each platform, and in the case of Tizen, two or more API sets may be provided for each platform.

The applications 3570 (for example, the application programs 3347) may include one or more applications that can perform functions, for example, home 3571, dialer 3572, SMS/MMS 3573, Instant Message (IM) 3574, browser 3575, camera 3576, alarm 3577, contacts 3578, voice dial 3579, e-mail 3580, calendar 3581, media player 3582, album 3583, clock 3584, health care (for example, measuring exercise quantity or blood sugar), and environment information (for example, atmospheric pressure, humidity, temperature information, and the like).

According to an embodiment, the applications 3570 may include an application (hereinafter, referred to as an “information exchange application” for convenience of description) that supports information exchange between the electronic device (for example, the electronic device 3301) and an external electronic device (for example, the electronic device 3302 or 3304). The information exchange application may include, for example, a notification relay application for transferring specific information to an external electronic device or a device management application for managing an external electronic device.

For example, the notification relay application may include a function of transferring, to the external electronic device (for example, the electronic device 3302 or 3304), notification information that is generated from the other applications (for example, the SMS/MMS application, the e-mail application, the health care application, the environmental information application, and the like) of the electronic device. Furthermore, the notification relay application may, for example, receive notification information from the external electronic device and may provide the received notification information to a user.

The device management application may manage (for example, install, delete, or update), for example, at least one function of an external electronic device (for example, the electronic device 3302 or 3304) that communicates with the electronic device (for example, a function of turning on/off the external electronic device itself (or some components thereof) or a function of adjusting the brightness (or resolution) of a display), applications that operate in the external electronic device, or services (for example, a call service, a message service, and the like) that are provided by the external electronic device.

According to an embodiment, the applications 3570 may include applications (for example, a health care application of a mobile medical appliance, and the like) designated according to the attributes of an external electronic device (for example, the electronic device 3302 or 3304). According to an embodiment, the applications 3570 may include applications received from an external electronic device (for example, the server 3306 or the electronic device 3302 or 3304). According to an embodiment, the applications 3570 may include a preloaded application or a third party application that may be downloaded from a server. The names of the elements of the program module 3510, according to the embodiment illustrated in the drawing, may vary according to the type of operating system.

According to various embodiments of the present disclosure, at least some of the programming module 3510 may be embodied as software, firmware, hardware, or a combination of at least two of them. At least some of the program module 3510 may be implemented (for example, executed) by, for example, the processor (for example, the processor 3410). At least some of the program module 3510 may include, for example, a module, a program, a routine, a set of instructions, and/or a process for performing one or more functions.

The term “module” as used herein may, for example, refer to a unit including one of hardware (e.g., circuitry), software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of processing circuitry, a dedicated processor, an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 3320), may cause the one or more processors to execute the function corresponding to the instruction. The computer-readable storage medium may be, for example, the memory 3330. According to various embodiments of the present disclosure, functions corresponding to the instructions may include functions of, by the processor, generating a first query based on a user input, identifying a response to the first query, and transmitting a second query generated at least based on the first query to an external electronic device, which can perform short-range communication, through at least one communication module based on a result of the query to set the second query to be processed by the external electronic device.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer using an interpreter, as well as machine codes made by a compiler. Any of the hardware devices as described above may be configured to work as one or more software modules in order to perform the operations according to various embodiments of the present disclosure, and vice versa.

The programming module according to the present disclosure may include one or more of the aforementioned components or may further include other additional components, or some of the aforementioned components may be omitted.

Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added.

Various example embodiments disclosed herein are provided merely to easily describe technical details of the present disclosure and to aid in understanding of the present disclosure, and are not intended to limit the scope of the present disclosure. Therefore, it should be understood that all modifications and changes or modified and changed forms based on the technical idea of the present disclosure fall within the scope of the present disclosure.

What is claimed is:

1. An electronic device comprising:
at least one communication module comprising communication circuitry; and
a processor comprising processing circuitry,
wherein the processor is configured to generate a first query based on an input, to identify a response to the first query, and to transmit a second query generated at least based on the first query to an external electronic device, which can perform short-range communication through the communication circuitry based on a result of the response to process the second query by the external electronic device.

2. The electronic device of claim 1, wherein the processor is configured cause the electronic device to transmit the first query to a server through the external electronic device and to receive the response from the server through the external electronic device.

3. The electronic device of claim 1, wherein the processor is configured to cause the electronic device to not transmit the second query when the result meets a first precondition and to cause the electronic device to transmit the second query when the result meets a second precondition.

4. The electronic device of claim 1, wherein the at least one communication module includes a first communication module comprising communication circuitry and a second communication module comprising communication circuitry, and the processor is configured to receive the first response from another external electronic device through the communication circuitry of the first communication module to transmit the second query to the external electronic device through the communication circuitry of the second communication module, and to select at least one external electronic device, which can process the second query, among the external electronic devices as the external electronic device at least based on the result.

5. The electronic device of claim 1, wherein the processor is configured to receive another response to the second query from the external electronic device and to provide the other response through output circuitry of an output device functionally connected to the processor.

6. The electronic device of claim 1, wherein the processor receives is configured to receive another response to a part of the second query from the external electronic device and to process another part of the second query at least based on the other response.

7. The electronic device of claim 1, wherein the processor is configured to identify at least one operation related to a task, to identify at least one external electronic device which can perform the at least one operation, respectively, and to transmit information on the at least one operation which can be processed by the corresponding electronic devices to the at least one identified external electronic devices, respectively.

8. The electronic device of claim 1, further comprising a microphone, wherein the processor is configured to acquire a voice input corresponding to the electronic device as at least a part of the input and to identify data corresponding to the acquired voice input as the query, wherein the processor acquires is configured to acquire a text input as at least a part of the input and to identify data corresponding to the acquired text input as the query.

9. The electronic device of claim 1, wherein the processor is configured to generate another query at least based on the first query, to identify a task to be performed in connection with the other query, to cause the electronic device to not transmit the other query when the result meets a first precondition, to transmit the other query to the external electronic device through the communication circuitry when the result meets a second precondition, to transmit the other query to another external electronic device, to receive information on the task from the other external electronic device as a response to the other query, and to transmit at least a part of the query to the external electronic device at least based on the result.

10. The electronic device of claim 1, wherein the task includes an operation related to electronic payment, and the processor is configured to identify an external electronic device including a module for performing the operation related to the electronic payment among the at least one external electronic device and to select the identified external electronic device as an external electronic device which can perform the task.

11. The electronic device of claim 1,
wherein the processor is configured to acquire a third query from another input corresponding to the electronic device, to identify a data domain corresponding to a task to be performed in connection with the third query, to determine whether a second external electronic device corresponding to the user can perform the task at least based on the data domain, to transmit at least a part of the query and/or a response to the query to the second external electronic device through the communication circuitry at least based on the determination that the second external electronic device can perform the task, to receive state information of the external electronic device from another external electronic device and to determine whether the task can be performed further based on the state information.

12. A method of processing an input by an electronic device, the method comprising:
generating a first query based on an input;
identifying a response to the first query;
transmitting a second query generated at least based on the first query to an external electronic device, which can perform short-range communication, through at least one communication module comprising communication circuitry, based on a result of the response; and
setting the second query to be processed by the external electronic device.

13. The method of claim 12, further comprising:
transmitting the first query to a server through the external electronic device; and
receiving the response from the server through the external electronic device.

14. The method of claim 12, further comprising:
causing the electronic device to not transmit the second query when the result meets a first precondition; and
transmitting the second query when the result meets a second precondition.

15. The method of claim 12, further comprising:
receiving the first response from another external electronic device through communication circuitry of a first communication module among the at least one communication module;
transmitting the second query to the external electronic device through communication circuitry of a second communication module among the at least one communication module; and
selecting at least one external electronic device, which can process the second query, among the external electronic devices as the external electronic device at least based on the result.

16. The method of claim 12, further comprising:
receiving another response to the second query from the external electronic device; and
providing the other response through an output device functionally connected to the processor.

17. The method of claim 12, further comprising:
receiving another response to a part of the second query from the external electronic device; and
processing another part of the second query at least based on the other response.

18. The method of claim 12, further comprising:
identifying at least one operation related to a task;
identifying at least one external electronic device which can perform the at least one operation, respectively; and
transmitting information on the at least one operation which can be processed by the corresponding electronic devices to the at least one identified external electronic devices, respectively.

19. The method of claim 12, further comprising:
acquiring a voice input of a user corresponding to the electronic device as at least a part of the user input through a microphone of the electronic device;
identifying data corresponding to the acquired voice input as the query; acquiring a text input as at least a part of the user input; and
identifying data corresponding to the acquired text input as the query.

20. The method of claim 12, further comprising:
generating another query at least based on the first query;
identifying a task to be performed in connection with the other query;
causing the electronic device to not transmit the other query when the result meets a first precondition;
transmitting the other query to the external electronic device through the communication circuitry of the communication module when the result meets a second precondition; transmitting the other query to another external electronic device;
receiving information on the task from the other external electronic device as a response to the other query; and
transmitting at least a part of the query to the external electronic device at least based on the result.

21. The method of claim 12, wherein the task includes an operation related to electronic payment, the method further comprising:
identifying an external electronic device including a module for performing the operation related to the electronic payment among the at least one external electronic device; and
selecting the identified external electronic device as an external electronic device which can perform the task.

22. The method of claim 12, further comprising:
acquiring a third query from another input corresponding to the electronic device;
identifying a data domain corresponding to a task to be performed in connection with the third query;
determining whether a second external electronic device corresponding to the user can perform the task at least based on the data domain;
transmitting at least a part of the query or a response to the query to the second external electronic device through the communication circuitry of a communication module at least based on the determination that the second external electronic device can perform the task; receiving state information of the external electronic device from another external electronic device; and
determining whether the external electronic device can perform the task further based on the state information.

23. A storage medium storing instructions which, when executed by at least one processor, cause the processor to perform at least one operation, the at least one operation comprising:
generating a first query based on an input;
identifying a response to the first query;
transmitting a second query generated at least based on the first query to an external electronic device, which can perform short-range communication, through communication circuitry of at least one communication module based on a result of the response; and
setting the second query to be processed by the external electronic device.
